(19) United States
(12) Patent Application Publication
(10) Pub. No.: US 2024/0279483 A1
(43) Pub. Date: Aug. 22, 2024

(54) A HIGH-EFFICIENT DECONTAMINANT ADDITIVE COMPRISING METAL OXIDE NANOPARTICLES IN A METALLIC OR SEMI-METALLIC NANOPARTICLE MATRIX, USEFUL TO BE ADDED IN PAINTS, FORMULATIONS OR THE LIKE FOR PROTECTING, COATING OR DECORATING, SOFT OR HARD, SURFACES

(71) Applicant: PHOTIO SPA, Santiago (CL)

(72) Inventors: Matias Ignacio MOYA ALARCON, Santiago (CL); Jaime Andrés ROVEGNO CABRERA, Santiago (CL)

(21) Appl. No.: 18/568,639

(22) PCT Filed: Jun. 8, 2022
(86) PCT No.: PCT/IB22/55348

§ 371 Date: Dec. 8, 2023

Related U.S. Application Data
(60) Provisional application No. 63/208,305, filed on Jun. 8, 2021.

(51) Int. Cl. C09D 5/14; C09D 7/40; C09D 7/61

(52) U.S. Cl. CPC C09D 5/14; C09D 7/61; C09D 7/67; C09D 7/68

(57) ABSTRACT

The present invention is related to a high-efficient and versatile/broad-spectrum decontaminant and disinfectant additive comprising metal oxide nanoparticles in a metallic or semi-metallic nanoparticle matrix, preferably, in a metallic or semi-metallic nanocatalyst matrix, being able to convert several types of common products used for protecting, coating or decorating surfaces, such as paints, varnishes, or the like, into decontaminant and disinfectant products mainly based on the metal oxide nanoparticle photocatalytic properties, and then, being able of removing/eliminating contaminants from an environment around outdoor or indoor surfaces on which the same is applied. It can be prepared as a powder “ready-to-use”, a solution to be sprayed or a formulation to be spread on a surface, and also can remove/eliminate contaminants such as CO, CO₂, NO, NO₂, SO₂, COVs, methane, particulate material, polycyclic aromatic compounds, methylene chloride, chlorofluorocarbons (CFCs), virus, bacteria, molds, water-soluble organic contaminants or organic contaminant dispersions or suspensions, among others.

This application is a National Stage of International Application No. PCT/IB2022/055348, filed 2022-06-08, which claims the benefit of U.S. Provisional Application No. 63/208305, filed 2021-06-08, the entireties of which are hereby incorporated herein by reference.

### FIELD OF APPLICATION

The present invention is related a high-efficient and broad-spectrum decontaminant and disinfectant additive comprising metal oxide nanoparticles in a metallic or semi-metallic nanoparticle matrix, preferably, a metallic or semi-metallic catalyst matrix, being able to convert several types of common products used for protecting, coating or decorating soft or hard surfaces, such as paints, varnishes, or the like, into decontaminant and disinfectant products mainly based on the metal oxide nanoparticle photocatalytic properties, and then, being able of removing/eliminating contaminants from an environment around outdoor or indoor surfaces either hard or soft surfaces on which the same is applied.

### BACKGROUND OF THE INVENTION

The atmospheric contamination is indiscriminately affecting all the population, no matter age, socioeconomic condition, gender, or nationality. Then, it is a transversal challenge can reduce such atmospheric contamination. It is possible to mention as contaminant gases: nitrogen oxides, carbon oxides, sulfur oxides or methane, which are responsible of phenomena like as acid rain, climate change and thermal inversion, which adversely affect at environmental level. In fact, there are several regulations to establish emission limits for emission sources and, also, the same promotes the use of clean processes and energy.

A photocatalysis procedure consists of a decontaminant degradation of air and water contaminants by activation of photocatalytic particles, which arise after exposing such particles to UV radiation (λ between 190 and 380 nm). Nanometer-sized photocatalytic particles promote an oxidation process strongly advanced on its surface, wherein contaminants as nitrous oxide, sulfur dioxide, carbon monoxide and carbon dioxide can be converted into inert compounds, being partially absorbed by the material containing nanoparticles, and the non-absorbed part is delivered to the environment but without representing a problem to the human health or environment.

Photocatalytic paints are known, existing several patent documents related to self-cleaning paints or decontaminants, where the most of them use TiO₂ as photocatalyst.

Particularly, CN107141935 (Chongqing Zhongding Sanzheng Tech Co Ltd) discloses a photocatalytic coating to purifying air, which is prepared from: 100-110 parts of a water-based silicone acrylic emulsion, 0.01-0.08 parts of polypyrrole, 2.2-2.8 parts of nano-titanium, 20-25 parts of silver acetate solution, 8-15 parts a wetting agent and a water-based dispersant, 0.04-2.0 parts of water-based antifoaming agent, 4-8 parts of a film-forming coadjuvant, 1.0-2.4 parts of a water-base leveling agent, 0.4-1.0 parts of an inhibiting agent and 40-45 parts of water. Such photocatalytic coating has a polypyrrole layer coating a nano-titanium dioxide surface, which remarkably improves the nano-titanium dioxide photocatalytic efficiency and obtaining an organic and inorganic filling compound of titanium dioxide to obtain a new low-cost high-efficient photocatalyst having a good integral performance, and while zinc ions are doped and show bactericidal functions and such coating can resist bacteria, sterilizing without contaminating and degrading air organic contaminant.

US20180133688A1 (Adelaide Research and Innovation Pty Ltd) is related to composite materials having a porous graphene-based foam matrix, having a surface functionalized with one or more of sulfur-containing functional groups, oxygen-containing functional groups, phospho-containing functional groups, and nitrogen-containing functional groups, wherein the porous inorganic micro-particles comprise or are made of diatomaceous earth, zeolites, silica, titania, clays carbonates, magnetite, alumina, titania, ZnO, SnO₂, ZrO₂, MgO, CuO, Fe₂O₃, Fe₃O₄ or combinations thereof, the metal oxide nano-particles are selected from oxides of iron, manganese, aluminum, titanium, zinc, gold, silver, copper, lithium, manganese, magnesium, cerium and combinations thereof, which is particularly well suited for use in removing ionic species from a liquid or gas, among various other applications.

WO2011033377A2 (Anderson Darren J; Das Anjan; Loukine Nikolai; Norton Danielle; Vive Nano Inc) is related to a multifunctional porous nanocomposite comprising at least two components, at least one component of which is a nanoparticle comprising a polymer and the other component comprises an inorganic phase, wherein the nanoparticle having a size in the range of 1 nm to 20 nm, is resistant to sintering at elevated temperature, can be selected from multiple nanoparticles, and corresponding to a polymer-stabilized inorganic nanoparticle, wherein the polymer comprises a polyelectrolyte, the nanoparticle component is dispersed uniformly throughout the inorganic phase and the other component is selected from the group consisting of amorphous carbon, pyrolytic carbon, activated carbon, charcoal, ash, graphite, fullerenes, nanotubes and diamond or metal oxides, mixed metal oxides, metal hydroxides, mixed metal hydroxides, metal oxyhydroxides, mixed metal oxyhydroxides, metal carbonates, tellurides and salts, including titanium dioxide, iron oxide, zirconium oxide, cerium oxide, magnesium oxide, silica, alumina, calcium oxide and aluminum oxide. The multifunctional nanocomposite is a catalyst, particularly, a photocatalyst, even mor particularly, a photocatalyst when exposed to visible light and after irradiation the same produce hydrogen. The multifunctional nanocomposite comprises more than 10% w nanoparticle, more than 30% v polymer-stabilized nanoparticle. The multifunctional nanocomposite comprises an inorganic phase stabilized by a polymeric phase, wherein the nanoparticle component is capable of sorption of organic substances and participating in ion exchange and can remove more than 300 grams of charged contaminant from aqueous solution per gram of nanocomposite, being particularly useful to remove arsenic from water. The multifunctional nanocomposite comprises at least one component capable of being magnetically separated.

WO2018023112A1 (Univ. Florida) is related to a visible light photocatalytic coating includes a metal oxide that in the presence of an organic contaminate that absorbs at least some visible light or includes the metal oxide and an auxiliary visible light absorbent, where upon absorption of degradation of the organic contaminate occurs. Contaminates can be microbes, such as bacteria, viruses, or fungi. The metal oxide is nanoparticulate or microparticulate. The metal oxide can be TiO₂. The coating can include an auxiliary dye having an absorbance of light in at least a portion of the visible spectrum. The coating can include a suspending agent, such as NaOH. The visible light photocatalyst coating can cover a surface of a device that is commonly handled or touched, such as a door, knob, rail, or counter.

US20150353381A1 (University of Houston System) is related to the synthesis, fabrication, and application of nanocomposite polymers in different form such as membrane/filter coatings, as beads, or as porous sponges, for the removal of microorganisms, heavy metals, organic, and inorganic chemicals from different contaminated water sources. The nanocomposite polymers comprising a polymer material comprising one or more natural biopolymers and one or more co-polymers; and nanoparticles selected from carbon, metal oxides or nanohybrids of carbon and metal oxide nanoparticles, wherein the nanoparticles are incorporated into the polymer material to form a mixture, which is formed into beads, colloids, sponges or hydrogels.

CN107043521 (Chongqing Zhongding Sanzheng Tech Co Ltd) is related to a catalytic material for improving clean-up performance, including raw material epoxy resin, two component polyurethane, acrylic resin, ZnO TiO₂Nano material, Ludox, adhesive for building, silicate, attapulgite modified, calcined kaolin, talcum powder, silane coupler KH 5, rilanit special, defoamer, coalescents, advection agent, mould inhibitor, organic solvent, pigment, and water. The addition of Ludox and adhesive for building, not only increase attachment and the adhesive capacity of catalysis material, the photocatalysis efficiency of titanium dioxide can be significantly improved. The catalyst material solves titanium dioxide shortcoming present in photocatalysis, the function of sterilization making coating and the function of organic pollution in the antibiotic and sterilizing and degraded air of efficient pollution-free.

CN104327574 (Ocean Univ China) is related to a micro/nano Cu₂O/ZnO composite material as a catalyst, having a strong visible light catalytic activity on organic pollutants, which can be used as an anti-pollution agent for preparing a high-performance environmental-friendly marine anti-pollution paint, the micro/nano Cu₂O/ZnO composite material has an actual-sea plate-adhesive period of 360 days and has a more excellent anti-pollution performance when being compared with a conventional pure Cu₂O material.

WO2019234463 (Szegedi Tudomanyegyetem) is related to a composition for forming a bifunctional thin layer on a substrate having superhydrophobic and photocatalytic activity comprising: (A) semiconductor photocatalyst particles which can be activated by visible light in an amount of from 2.0% to 9.5% by weight; (B) a low surface energy polymer carrier in an amount of from 0.5 to 8.0% by weight; and (C) to 100% by weight of a solvent/dispersing medium.

CN107383947 (Jiangyin Tianbang Paint Ltd by Share Ltd) is related to a kind of nanometer photocatalytic coating, comprising: 10 20 parts of zinc oxide, 20 40 parts of titanium dioxide, 13 parts of noble metal, propylene Korean pine (2 p-nitrophenyls) 34 parts of 10 20 parts of thiadiazoles, 56 parts of vanillic aldehyde and other auxiliary agents, having a particle diameter of 3-7 nm ZnO, and 8-12 nm TiO₂; an having a very strong redox ability in the presence of visible ray, a stable chemical performance. The photocatalyst coating can completely decomposed harmful organic substances such as the harmful organic substances such as formaldehyde, toluene, dimethylbenzene, ammonia, radon, TVOC, pollutant, foul smell, bacterium, virus, microorganism into harmless CO₂ and H₂O, thus the characteristic such as superficial air pollutant and automatically cleaning is removed with automatic, consistency of performance and without producing a secondary pollution.

CN109021635 (Shanghai Miru New Material Tech Co Ltd) is related to a kind of photocatalytic wall protective agent comprising (in parts by weight): 1-5 parts of nano photo-catalytic, 0.2-10 parts of iron content calcium phosphate compound; concentration is 500-2000 parts of the methane-siliconic acid sodium solution of 25-35 wt % and 500-3000 parts of water. The nano photo-catalyst is two or more in nano-titanium dioxide, nano zine oxide, nanometer tungsten oxide and nanometer pucherite. The protective agent is transparent and can make material surface obtain hydrophobic protection after being coated on traditional building material surface; photo-catalyst is generated simultaneously.

CN109370280 (Univ Heilongjiang) is related to a high-performance photocatalytic coating to purify the air of a room comprising: pigment 5-7 g, polyaniline 0.04-0.06 g, nano-titanium dioxide 0.5-0.7 g, carbon dust 0.1-0.15 g, solvent 250-300 mL. Indoor polluted gas can be effectively removed after polyaniline and carbon dust is added, reduces the concentration of pollution gas in environment and is safety.

CN102850883 (Yizheng Tongfa Building Curing Materials Factory) is related to a photocatalytic nano multifunctional external wall paint, belonging to the technical field of external wall paint production, which mainly comprises an acrylic emulsion, assistants and a filler, and is characterized by also comprising nano TiO₂, SiO₂ and an inorganic antimicrobial mold preventive. It has a well nano material dispersity and stability in the paint, adding to the same a photocatalytic property without adversely affecting its original cracking resistance, aging resistance, weather resistance, high coverage rate and high pollution resistance. It can mainly use in buildings, industry and the like, and particularly high-rise building external walls.

CN104403450 (Bengbu Jinyu Printing Material Co Ltd) is related to a photocatalytic exterior wall paint comprising (in parts by weight): 15 to 25 parts of nano photocatalyst dispersion liquid, 10 to 20 parts of water, 5 to 15 parts of titanium dioxide, 10 to 14 parts of heavy calcium carbonate, 2 to 4 parts of talcum powder, 1 to 3 parts of porous powder quartz, 0.5 to 1.5 parts of aluminum silicate, 0.5 to 1.5 parts of antifoaming agent, 0.5 to 1.5 parts of wetting agent, 1 to 3 parts of dispersant, 16 to 20 parts of organic silicon emulsion, and 10 to 14 parts of acrylic acid emulsion. The prepared photocatalytic exterior wall paint has a good using effect, safety, and reliability.

CL202002304 (Comercial Grupo KRC Limitada) is related to Cu-Ag nanoparticles-based additive in overprinting varnishes to apply in labels, packages, books, paper bags, among others to conferring them antibacterial and antiviral properties to eliminate bacteria or virus on the external surface of the product.

Thus, prior art as mentioned before are mainly based on the use of titanium oxide (TiO₂) and zinc oxide (ZnO) as photocatalytic and in minimal case, it is further used copper oxide (CuO and Cu₂O). As opposed, the present decontaminant additive uses several photocatalytic components and catalysts to increase the degradation or oxidation speed and increasing the contaminant spectrum to be treated.

Prior art is related to CO₂ and NOx contaminants. While the present decontaminant additive is able to treat more than 10 types of different types of contaminants (CO, CO₂, NO₂, NO, SO₂, H₂S, volatile organic compounds (COVs), organic compounds, virus, bacteria, molds), which comprises more than 80% by volume of all the contaminates in the troposphere.

Thus, the present invention is related to a high-efficient and versatile decontaminant and disinfectant additive comprising metal oxide nanoparticles in a metallic or semi-metallic nanoparticle matrix, preferably, in a metallic or semi-metallic nanocatalyst matrix, being able to convert several types of common products used for protecting, coating or decorating soft or hard surfaces, such as paints, varnishes, or the like, into decontaminant and disinfectant products mainly based on the metal oxide nanoparticle photocatalytic properties, and then, being able of removing/eliminating contaminants from an environment around outdoor or indoor surfaces either hard or soft surfaces on which the same is applied. Such indoor or outdoor surfaces can correspond to building surfaces such as building walls, building coatings, furniture surfaces, stair railway surfaces, or any indoor or outdoor surface of houses, schools, hospitals, buildings, among others, as well industrial surfaces such as settling pools, inner or outer walls of industrial reactors, polymer pieces, among others. Such soft surfaces can correspond to fabrics, plastic films, filter membranes, among others. But even the present decontaminant additive could be added to an asphaltic mixture, a concrete sealing, a polymer masterbatch, among others. Such purifying effect can also comprise removing/eliminating air or water contamination. Further, the present decontaminant additive can be prepared as a powder “ready-to-use”, a solution to be sprayed as a liquid or a formulation to be spread on a soft or hard surface. The present decontaminant additive can remove/eliminate contaminants such as CO, CO₂, NO, NO₂, SO₂, H₂S, COVs, methane, ammonia, formaldehyde, particulate material, lead, polycyclic aromatic compounds such as benzopyrene, benzene, xylene, trimethylbenzene and aliphatic hydrocarbons, hydrogen fluoride or hydrated hydrogen n fluoride/hydrofluoric acid, methylene chloride and chlorofluorocarbons (CFCs), virus, bacteria, molds, water-soluble organic contaminants or organic contaminant dispersions or suspensions, among others.

### BRIEF DESCRIPTION OF THE DRAWINGS

FIG. 1. Comparative graph to the efficacy to the contaminant remotion between the present decontaminant additive vs. titanium dioxide (TiO₂) nanoparticles vs. a combination of TiO₂ and alumina (Al₂O₃) nanoparticles.

FIG. 2. Comparative graph of the efficacy of contaminant remotion between TiO₂ nanoparticles vs. a combination of TiO₂ and copper nanoparticles.

FIG. 3. Pilot photocatalytic Scheme. A: Decontaminant mixture+air. B: MFC; C: Photoreactor; and D: GC.

FIG. 4. Diffuse Reflectance Spectrum of the sample (red) and acrylic (gray).

FIG. 5. CO Transformation and CO₂ formation by means of photocatalytic reaction at a rate of 140 ml/min with an initial CO concentration of 650 ppm.

FIG. 6. CO Transformation and CO₂ formation by means of photocatalytic reaction at a rate of 200 ml/min with an initial CO concentration of 300 ppm.

FIGS. 7A-7L. CO Transformation and CO₂ formation per plate.

FIG. 8. Diffuse reflectance spectrum of the samples as a function of the wavelength.

FIG. 9A and 9B. Diffuse reflectance spectra of samples, separated by trends observed.

FIG. 10. Kubelka-Munk absorption spectrum as a function of wavelength.

FIGS. 11A-11J. Curves of the Kubelka-Munk function as a function of energy. Red line shows the value of Eg.

FIG. 12. Diffuse reflectance and Kubelka-munk spectra of sample 1.

FIGS. 13A-13C. Results of methylene blue degradation to white ink (FIG. 13A), metal ink (FIG. 13B) and paint in leather (Krosta, FIG. 13C). A=control, B=0.1%, C=0.3%

FIGS. 14A-14F. Rose Bengal Absorption at different pH values free of the additive of the present invention (FIG. 14A) and Rose Bengal Absorption at different pH values pH to adhesive/Sealant with the present additive (FIG. 14B). Rose Bengal photo-degradation in adhesive/sealant at pH 3 with (Photio I and Photio II) and free of the present additive (FIG. 14C), at pH 5.5 with (Photio I and Photio II) and free of the present additive (FIG. 14D), at pH 6.9 with (Photio I and Photio II) and free of the present additive (FIG. 14E) and at pH 11 with (Photio I and Photio II) and free of the present additive (FIG. 14F).

FIGS. 15A-15F. Methylene Blue Absorption at different pH values free of the additive of the present invention (FIG. 15A) and Methylene Blue Absorption at different pH values pH to adhesive/Sealant with the present additive (FIG. 15B). Methylene Blue photo-degradation in adhesive/sealant at pH 3 with (Photio I and Photio II) and free of the present additive (FIG. 15C), at pH 5.5 with (Photio I and Photio II) and free of the present additive (FIG. 15D), at pH 6.9 with (Photio I and Photio II) and free of the present additive (FIG. 15E) and at pH 11 with (Photio I and Photio II) and free of the present additive (FIG. 15F).

FIG. 16. Methylene blue absorption at different pH values in presence of the present additive. Powder sealant mixtures (P) are present at different concentrations and dispersions (1%, 5%, 10% y 15%), and sealant was diluted (10%) in dispersion.

FIGS. 17A- 17F. Rhodamine B Absorption at different pH values free of the additive of the present invention (FIG. 15A) and Rhodamine B Absorption at different pH values pH to adhesive/Sealant with the present additive (FIG. 15B). Methylene Blue photo-degradation in adhesive/sealant at pH 3 with (Photo I and Photio II) and free of the present additive (FIG. 15C), at pH 5.5 with (Photo I and Photio II) and free of the present additive (FIG. 15D), at pH 6.9 with (Photio I and Photio II) and free of the present additive (FIG. 15E) and at pH 11 with (Photio I and Photio II) and free of the present additive (FIG. 15F).

FIGS. 18A-18F. Methyl Orange Absorption at different pH values free of the additive of the present invention (FIG. 15A) and Methyl Orange Absorption at different pH values pH to adhesive/Sealant with the present additive (FIG. 15B). Methylene Blue photo-degradation in adhesive/sealant at pH 3 with (Photio I and Photio II) and free of the present additive (FIG. 15C), at pH 5.5 with (Photio I and Photio II) and free of the present additive (FIG. 15D), at pH 6.9 with (Photio I and Photio II) and free of the present additive (FIG. 15E) and at pH 11 with (Photio I and Photio II) and free of the present additive (FIG. 15F).

FIGS. 19A-19C. Colorimetric Graphs—AM Degradation in cement with Sika® Antisol® with and free of the present additive. FIG. 19A DL vs time. FIG. 19B Da vs time. Db vs time. A=control, B=present additive.

FIG. 20. AM Degradation results in film with Sika® Antisol®, Control (black) and Sika® Antisol®+the present additive, P1% (Red).

FIG. 21. AM Degradation results in film with Sika® Antisol®, Control (black), and Sika® Antisol® +the present additive, P1% (Red).

FIG. 22. AM degradation results in film con Sika® Antisol®, Control (black), Sika® Antisol®+the present additive 0.1% (Red), Sika® Antisol®+the present additive 0.5% (blue), Sika® Antisol® +the present additive 1% (green).

FIG. 23. AM degradation results in PLA suspension, control (black), 0.3% the present additive (red) and 3% the present additive (blue).

FIGS. 24A and 24B. Parameter dB evolution vs time to AM (FIG. 24A) and Rhodamine B (FIG. 24B)

FIGS. 25A-25H. Room temperature vs baseline—light gray and present additive—black gray (FIG. 25A), Humidity vs baseline—light gray and present additive—black gray (FIG. 25B), PM1 vs baseline—light gray and present additive—black gray (FIG. 25C), PM2.5 vs baseline—light gray and present additive—black gray (FIG. 25D), PM10 vs baseline—light gray and present additive—black gray (FIG. 25E), CO vs baseline—light gray and present additive—black gray (FIG. 25F), CH₄ vs baseline—light gray and present additive—black gray (FIG. 25G), NO vs baseline—light gray and present additive—black gray (FIG. 25H).

FIGS. 26A-26E. Bandgap TiO₂ (T, FIG. 26A), ZnO (Z, FIG. 26B), Al₂O₃ (A, FIG. 26C), CuO (CO, FIG. 26D) and Cu (C, FIG. 26E).

FIGS. 27A and 27B. A first and second evaluation of nanoparticles combination, as TiO₂ (T), T+ZnO (Z), T+CuO (CO), T+Al₂O₃ (A), T+Cu (C), Z, Z+T, Z+CO, Z+A, Z+C.

FIGS. 28A and 28B. Imagens of water drop on the surface prepared with oleic acid to evaluate contact angle using software ImageJ.

### DETAILED DESCRIPTION OF THE INVENTION

The present high-efficient decontaminant and versatile/broad-spectrum decontaminant and disinfectant additive comprising metal oxide nanoparticles in a metallic or semi-metallic nanoparticle matrix, preferably, in a metallic or semi-metallic nanocatalyst matrix, and under presence of or submitted to UV radiation, a continuous degradation of contaminant gases is promoted, being such contaminant gases, the ones issued by any type of industrial or household sources. The present high-efficient and broad-spectrum decontaminant and disinfectant additive can be used in common products for protecting, coating or decorating soft or hard surfaces converting the same into a decontaminant and disinfectant of surfaces without adversely affect the desired physical-chemical of the original product in the present additive is added. Also, the present decontaminant and disinfectant additive can remove/eliminate organic contaminants from a liquid mass in contact with a hard or soft surface treated with a common protecting product to which the present decontaminant and disinfectant additive has been added. But even the present decontaminant and disinfectant additive could be added into an asphaltic mixture, a concrete sealing, a polymer masterbatch, among others.

Also, the present decontaminant and disinfectant additive after added into a common protecting product to any kind of surfaces, allows to obtain a self-cleaning, decontaminant and disinfectant protecting product of surfaces; an anticorrosive, decontaminant and disinfectant protecting product of surfaces or a reduced heat dissipation, decontaminant and disinfectant protecting product of surfaces.

The present decontaminant and disinfectant additive comprising 4 photocatalytic metal oxide nanoparticles: TiO₂, ZnO, Al₂O₃, and CuO. Such metal oxide nanoparticles are present at a ratio TiO₂: ZnO: Al₂O₃: CuO is 0−<50:0−<50:0−<50:0−<20, respectively. Preferably, such metal oxide nanoparticles are present at a ratio TiO₂: ZnO: Al₂O₃: CuO is 35:30:15:15-3, respectively. Metal oxide nanoparticles having the following range of nanoparticle size: ZnO, from 10 nm to 150 nm, preferably, from 10 nm to 100 nm; Al₂O₃, 10 nm to 150 nm, preferably, from 10 nm to 100 nm; TiO₂, 10 nm to 150 nm, preferably from 10 nm to 30 nm; and CuO, from 10 to 150 nm, preferably from 40 nm to 60 nm. Such aluminum trioxide (Al₂O₃) is selected from γAl₂O₃. Such titanium dioxide is selected from TiO₂, anastase phase. Preferably, 99.99% Al₂O₃ nanoparticles having a size ranging from 10 nm to 100 nm. Preferably, 99.99% TiO₂ nanoparticles having a size ranging from 10 nm to 30 nm.

While such metallic or semi-metallic nanoparticle matrix, preferably, such metallic or semi-metallic nanocatalyst matrix, is preferably selected from a nanocopper matrix having a nanoparticle size <100 nm. Preferably, 99.99% Cu nanoparticles having a size <100 nm. Ratio metal oxide nanoparticles to nanometal matrix is as follows: TiO₂:ZnO:Al₂O₃:CuO:Cu is 0−<50:0−<50:0−<50:0−<20:0−<20. Preferably, such ratio metal oxide nanoparticles to nanometal matrix are as follows: TiO₂:ZnO: Al₂O₃:CuO:Cu is 35:30:15:15-3:5.

It should be noted that such metallic or semi-metallic nanoparticle matrix content, preferably, such metallic or semi-metallic nanocatalyst matrix content can vary depending on the nature of the common protecting product to which the present decontaminant and disinfectant additive is added, for example a paint to be in contact with water or a varnish to be in contact with a solvent, among others.

Further, such metallic or semi-metallic nanoparticle matrix, preferably, such metallic or semi-metallic nanocatalyst matrix can be selected from nanocopper, nanosilver, nanogold, among other. But even, such nanocatalyst matrix could be also graphene or a graphene-derived material, among others.

Optionally, the present decontaminant additive can further comprise a superplasticizer, which can be selected from an anionic surfactant having functional groups selected from hydroxyl, sulphonate or carboxyl; plastificizers/water reducers having a reducing power within a percent range of 5-12%, which can be selected from modified lignosulphonates or hydroxycarboxylic acids; superplastificizers/water reducers having a high reducing activity within a percent value >12%), which can be selected from condensed salts of sulphonated naphthalene and formaldehyde (SNF); condensed salts of sulphonated melamine and formaldehyde (SMF); Polymers of vinylic synthesis and/or polycarboxylate polyeters (PCE). Preferably, the superplasticizer is a polycaboxylate-based superplasticizer.

Such superplasticizer can be used even in a percent amount >0% to improve the decontaminant and disinfectant effect of the present additive.

The present decontaminant and disinfectant additive can be added into a common protecting product in a percent amount from >0 to 25% w/w (additive/product), preferably from 0.1 to 15% w/w (additive/product), more preferably from 0.1 to 6% w/w (additive/product). The ratio additive: product can be reduced without affecting adversely such decontaminant and disinfectant properties when the present additive further comprises a superplasticizer. As example, a conversion over 45% to CO and CO₂ gases was measured in plates (9.5 cm×10 cm) treated with a paint containing the present decontaminant and disinfectant additive.

Further, based on experiments using an organic colorant (methyl orange) as organic contaminant into a liquid solution (water) inside a container having inner walls treated with a paint to which the present decontaminant and disinfectant additive was added, a high decontaminant (remotion) yield of such organic contaminant from such contaminated aqueous solution was achieved.

The present decontaminant and disinfectant additive after irradiated with UV light at a wavelength ranging from 190 nm and 380 nm, promotes a synergistic degradation and/or capture of greenhouse effect gases, local contaminant gases or the like around of indoor or outdoor, soft or hard, surfaces treated with a common protecting product to which the present decontaminant and disinfectant additive was added. As well, virus, bacteria, molds or any microorganism can be removed/eliminated from indoor or outdoor, soft or hard, surfaces after treated with a common protecting product to which the present decontaminant and disinfectant additive was added.

Similarly, the present decontaminant and disinfectant additive after irradiated with UV light at a wavelength ranging from 190 nm and 380 nm, promotes a synergistic degradation and/or capture of organic contaminants suspended, dissolved or the like, in a mass of liquid/solution which is in contact with a soft or hard surface treated with a common protecting product to which the present decontaminant and disinfectant additive is added.

Further, contaminant gases or organic liquids/solution can be degraded and/or captured on a surface of an asphaltic mixture, a concrete sealing, a polymer masterbatch, among others, to which the present decontaminant and disinfectant additive is added.

Under normal humidity environments, the present decontaminant and disinfectant additive promotes an advanced oxidation process on the surface treated with a common protecting product to which the present decontaminant and disinfectant additive is added, wherein gaseous contaminants such as nitrous oxide, sulfur dioxide, carbon monoxide and carbon dioxide are converted into inert compounds, wherein a part is absorbed by the present decontaminant and disinfectant additive and another part is released to the environment but without representing a problem to the human health or the environment.

The efficacy of the present decontaminant and disinfectant additive was lab-tested in organic liquids (methyl blue and orange), obtaining a remotion upper to 90%. Also, it was tested the remotion of CO by means of a closed cylindric reactor internally coated with a paint with the present metal oxide nanoparticle aggregates and using UVC lamps, achieving a reduction of 90% in less than 6 hours. Further, it was tested the conversion of CO and CO₂ gases from plates (9.5 cm×10 cm) treated with a paint to which the present decontaminant and disinfectant additive was added, and this conversion was compared faced to the present decontaminant and disinfectant additive further comprising an ether-polycarboxylate superplasticizer and metal oxide nanoparticles isolated or mixed with a combination having less than the above mentioned 4 metal oxide nanoparticles. Also, it was performed a comparison to different ratios (w/w) of additive: product.

To experimental assays was used a methyl orange solution having an initial concentration of 14,6×10⁻³ mg/ml. To the tests, a Photocatalytic Fenton process was implemented activating plates having an area of 0.01 m² and coated with a paint to which was added 0.1% and 10% of: 1) the present additive, 2) TiO₂, 3) TiO₂+Al₂O₃, 4) TiO₂+Cu. The activation procedure was performed with an UV lamp of 40 W submerged in a methyl orange-water solution while the efficacy in removing the contaminant (methyl orange) was measured by UV-vis spectroscopy and image graph analysis, to determine the variation of methyl orange concentration along to the time.

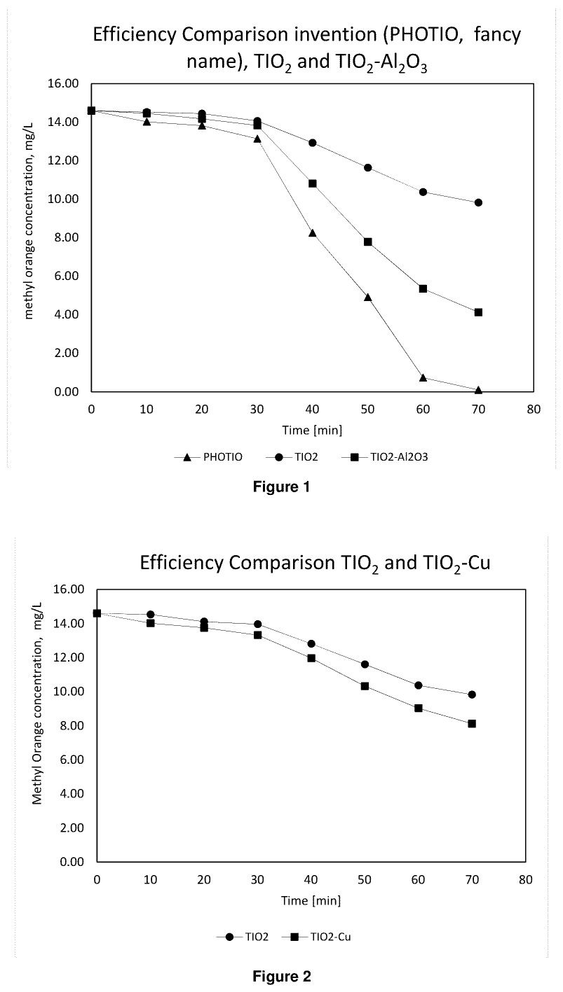

As showed FIG. 1, compared the remotion (mg/L/min) based on the present invention, TiO₂ and Al₂O₃+TiO₂, when used TiO₂ y Al₂O₃ the efficacy of remotion remarkably improved and methyl orange concentration decreases from 10 mg/L to 4 mg/L. TiO₂ result was similar. But the present additive is even better.

Tables 1 and 2 below, summarize the above-mentioned results, which are also illustrated in FIGS. 1 and 2, respectively.

TABLE 1

| | Present additive | TiO₂ | Al₂O₃ − TiO₂ |
|---|---|---|---|
| | Methyl Orange | Methyl Orange | Methyl Orange |
| Time | Concentration | Concentration | Concentration |
| Min | 10⁻³ mg/ml | 10⁻³ mg/ml | 10⁻³ mg/ml |
| 0 | 14.60 | 14.60 | 14.60 |
| 10 | 14.02 | 14.52 | 14.45 |
| 20 | 13.82 | 14.44 | 14.17 |
| 30 | 13.14 | 14.06 | 13.83 |
| 40 | 8.25 | 12.92 | 10.81 |
| 50 | 4.91 | 11.63 | 7.78 |
| 60 | 0.74 | 10.37 | 5.35 |
| 70 | 0.10 | 9.82 | 4.13 |

FIG. 2 shows a remotion graphs to TiO₂ and a Cu+TiO₂ aggregate, wherein the last remarkably improves the efficacy of remotion and the methyl orange concentration was reduced from 10 mg/L to 8 mg/L. TiO₂ result was similar.

TABLE 2

| | TiO₂ | TiO₂ + Cu |
|---|---|---|
| | Methyl Orange | Methyl Orange |
| Time | Concentration | Concentration |
| Min | 10⁻³ mg/ml | 10⁻³ mg/ml |
| 0 | 14.60 | 14.60 |
| 10 | 14.53 | 14.02 |
| 20 | 14.12 | 13.75 |
| 30 | 13.96 | 13.32 |
| 40 | 12.81 | 11.96 |
| 50 | 11.61 | 10.32 |
| 60 | 10.37 | 9.03 |
| 70 | 9.83 | 8.12 |

An alternative modality of the invention comprises a decontaminant and disinfectant additive having the following composition (w/w): 35% TiO₂ (anatase), 30% ZnO, 15% Al₂O₃ (gamma phase), 15% CuO and 5% Cu, and the same was applied at a concentration (w/w) from 0.5-6% in a commercial paint to produce a high-efficient decontaminant paint.

### EXAMPLES

### Example 1: Addition Into a Paint

A powder additive of metal oxide nanoparticles having an average nanoparticle size ranging from between 10 nm to 80 nm is added into a container having a nanometal matrix related to the paint (water or a solvent) to which the present powder additive is added. Then, the powder additive is mixed with paint in a range from 0.5% w/w to 20% w/w at a temperature of 20° C. under an extraction hood. Particularly, 1% w/w of the powder is added to an acrylic (solvent-based) paint, having the powder a composition of: 35% w/w TiO₂ (anastase phase), 30% w/w ZnO, 15% w/w Al₂O₃ (gamma phase), 15% w/w CuO and 5% w/w Cu.

### Example 2: Addition Into Plastic

A powder additive of metal oxide nanoparticle is added to a masterbatch corresponding to a high temperature-fluidized resin mixture to obtain a final concentration between 1% w/w to 35% w/w. After, the masterbatch is added into a polymer matric by extrusion at a temperature from 150° C. to 280° C., and a filament is obtained, which can be directly used to elaborate a final product.

### PLA Tests

The photocatalytic behavoir of the present additive in PLA (Polylactic Acid Biopolymer) was evaluated. Firstly, the present additive as water nanoparticle mixture together with a polysorbate-based dispersant or any other dispersant which can be optimally associated to the final product was used. PLA is a biopolymer used to 3D printing, which is obtained from agronomical residues to be applied as containers, coatings, among others. The present additive is added to PLA using by two ways. A first way, using a dissolution and a chloroform modification. A second way corresponds to a superficial ethyl acetate modification. Control sample is PLA submitted to a dissolution and reconstitution process. Sample 1 is PLA submitted to a dissolution process with 0.0030 g of the present additive (powder). Sample 2 is PLA submitted to a dissolution process with 0.030 g of the present additive (powder). Photocatalytic activity tests are based on ISO 16780 norm. ISO 16780:2010 norm specifies a method for determining the photocatalytic activity of surfaces by methylene blue (AM) degradation in aqueous solution using non-natural UV radiation and characterizes the capability of photoactive surfaces to degrade the dissolved organic molecules.

### Methylene Blue Degradation, UV-VIS

Methylene blue degradation was studied in the surface of PLA samples suspended in a colorant solution. After submitted to radiation, a colorant solution is degraded, losing color and becoming transparent along to the exposure time. Degrading reaction can be catalyzed in presence a photocatalyst material, and a degradation occurs in a lower time compared to being free of a catalyst. Suspension way is used. To evaluate 1 g comminuted PLA (small parts) is added into a vessel to then adding 25 mL methylene blue (0.02 mM). Mixture is conditioned in darkness at 400 rpm, 30 minutes since no absorption is expected from the material. 1 g PLA filaments are added to 20 g chloroform and sporadically agitated to react. Once dissolved, PLA is deposited in a glass Petri plate wherein all the content is dissolved. Sample are dried for at least 6 hours or more up to solidifying. To modifying, the present additive is added to achieve the desired concentration and is sporadically agitated to distribute the present additive in the matrix. Once dissolved, dispersed and homogeneously deposited, the generated PLA and PLA+the present additive samples, the glass polymer film is detached and comminuted prior to be in the following assays. Then samples are contacted with a colorant under constant agitation and UVC radiation, wherein the colorant decomposition is observed as a reduction in absorbance, which reflects the photocatalyst presence. 1 g of samples is detached from film comminuting the samples to flakes or similar and carried out to a vessel (100 ml). 1 g PLA modified with the present additive coming from a dried film is added to a vessel (100 ml) as described above. 25 ml of methylene blue solution (0.02 mM) are added to the prepared samples, which then are submitted to darkness for 30 min, agitating to 400 rpm, and if decoloring is occurred solution is changed after filtering the solution with a conventional filtering paper and discarding the solution to recover a solid material remaining in the filtering paper. If solution does not notoriously change color changes of absorbance are evaluated by UV-visible spectroscopy for 30 minutes with fresh solution. If absorbance does not vary beyond 10% sample is ready to photodegradation evaluation. UVC is light on under constant agitation. Distance between samples and lamps is 20 cm. Absorbance is measured at 1 hour and 2 hours. Points are added depending on the sample. (A/Ao)*100 graphs are generated to observe a normalized changes of initial absorbance (Ao) vs radiation time (A), contrasting results between control and samples with the present additive. Table 3 shows (A/Ao)*100 variation results to samples (control, 0.3% and 3% present additive) after 0, 1, 2 and 3 hours. FIG. 23 shows such results.

TABLE 3
AM degradation results in suspension, PLA
and PLA + the present additive (0.3% y 3%)

| | | | |
|---|---|---|---|
| t | Control | 0.3% | 3% |

| (h) | Average | SD | Average | SD | Average | SD |
|---|---|---|---|---|---|---|
| 0 | 100% | 0% | 100% | 0% | 100% | 0% |
| 1 | 107% | 2% | 100% | 2% | 97% | 1% |
| 2 | 104% | 5% | 99% | 2% | 97% | 5% |
| 3 | 105% | 1% | 99% | 3% | 92% | 4% |

FIG. 23 shows that absorbance to control varies to values greater the initial ones while after added the present additive, degradation from the initial absorbance is up to 92±4% (including the present additive at 3%).

Absorbance variation can allow quantifying colorant concentration and after applied radiation colorant is decomposed due to its nature. In presence of a catalyst, reaction velocity increases while in absence of a catalyst, an isolated effect is observed. After added the present additive to PLA, a greater methylene blue degradation is achieved compared to non-modified PLA, evidencing a catalyzed reaction and a material having decontaminant potential capacity. After added the present additive (3%) in the PLA matrix a photocatalytic material is obtained, disposed as film, which can be able to degrading methylene blue in solution reducing its absorbance from 100% to 92±4% after submitted to 3 hours of UVC light radiation while PLA free of the present additive shows an increase in the initial absorbance, achieving up to 105±1%. Thus, a greater methylene blue degradation occurs to PLA+the present additive, demonstrating that such doping confers photocatalytic activity under UVC radiation. In fact, a greater degradation increase occurs in presence of the present additive at 3% under UVC light and constant agitation (400 rpm).

### Example 3: Photocatalytic Effect in Plates

### CO Tests

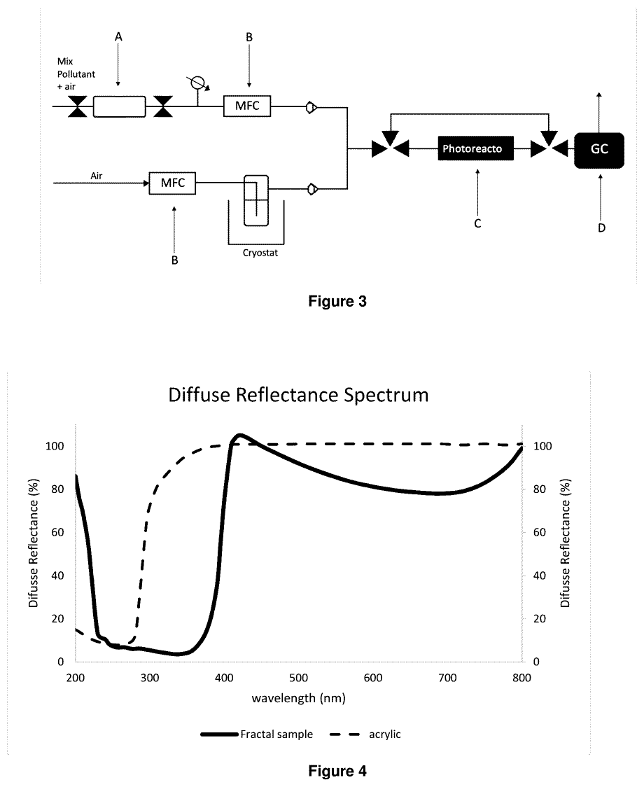

A photocatalytic pilot was designed as showed FIG. 3. Two mass flow meters (MFC), a reservoir, a cryostat and a gas scrubber balloon to control the ambient flow humidity and a gas chromatography-Thermical Conductivity Detector (GC-TCD) to analyze the gas composition in continuous. A 3-way valve set as bypass is allowing the monitoring of the contaminant concentration entering in the photoreactor. Xenon 35W bulbs having emissions within the range of 330-680 nm are located at 18 cm of distance from the photoreactor.

Hereinabove, samples are as stated in Table 4, with the only exception that another definition can be indicated.

TABLE 4
Composition of the samples

| Component/plate | 1 | A | B | C | D | E* | F* | G* | H* | I* |
|---|---|---|---|---|---|---|---|---|---|---|
| TiO₂ | 35% | 35% | 35% | 35% | 35% | 2.63 g | 2.63 g | 2.63 g | 2.63 g | 2.63 g |
| ZnO | 30% | 30% | 30% | 30% | 30% | — | — | 2.23 g | — | — |
| Al₂O₃ | 15% | 15% | 15% | 15% | 15% | — | — | — | 1.13 g | — |
| Cu | 5% | 5% | 5% | 5% | 5% | — | 0.38 g | — | — | — |
| CuO | 15% | 15% | 3% | 15% | 15% | — | — | — | — | 1.13 g |
| Ether | — | 5 mg | — | — | — | — | — | — | — | — |
| polycarboxylate- | | | | | | | | | | |
| based | | | | | | | | | | |
| superplasticizer | | | | | | | | | | |

*the present decontaminant additive was added into paint to generate a total mass of 50 g

Before determining the photocatalytic performance to the samples, the optical properties of the same were studied to stablish a wavelength to absorb energy, a range of emission of the bulb to be used and the band gap between the valence and conduction bands of the material under study.

FIG. 4 shows the diffuse reflectance spectrum (%) of the sample and the acrylic material to be used in the photoreactor, and the present decontaminant additive shows 2 bands, a first band located at the higher visible zone and near IR (465-785 nm) having a maximum of 680 nm, and a second band located at the UV zone (390-230 nm) having a maximum of absorption at 350 nm. Such second band shows a typical shape of a semiconductor. Consequently, enough energy has been absorbed by the samples to generate radical species inside the photoreactor, which are able to oxidize the surrounding environmental.

Previously, a stock/reservoir consisting of an air-diluted contaminant mixture was prepared. Such stock/reservoir is a cylinder of 300 mL, which can be pressurized until 1800 psi at room temperature. To prepare such reservoir, first vacuum is performed by 10 minutes into the equip (3flex, Micromerictics). This equip can carefully dose a pressure by a desired contaminant, and a concentration of app. 0.3-1% air is obtained, and later, adjusted to a total pressure of 80-85 bars with extra pure air added directly from the cylinder equipped with a nanometer. Subsequently, the reservoir is connected to the pilot (FIG. 3) in a manometer to expand the gas in the reservoir at room pressure. Air passes through the saturator in the cryostat, which is at 5° C., and then saturated air with 6.5449 mm Hg of water results, corresponding to a 27.5% relative humidity at 25° C.

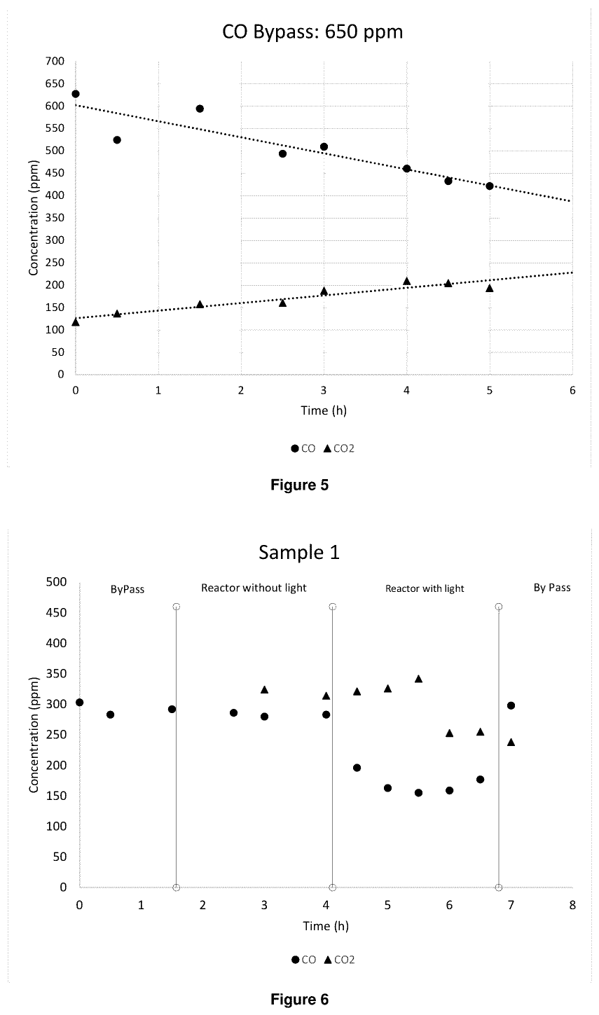

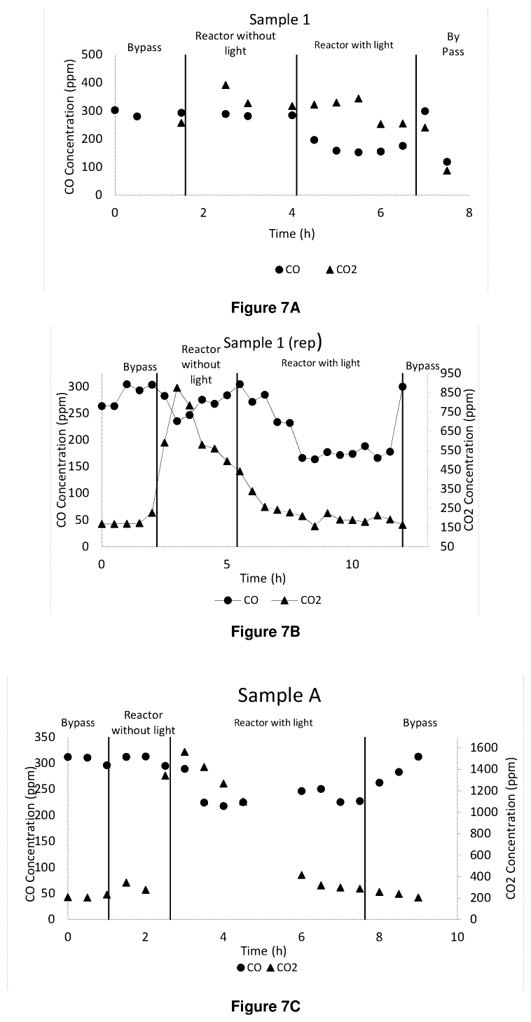

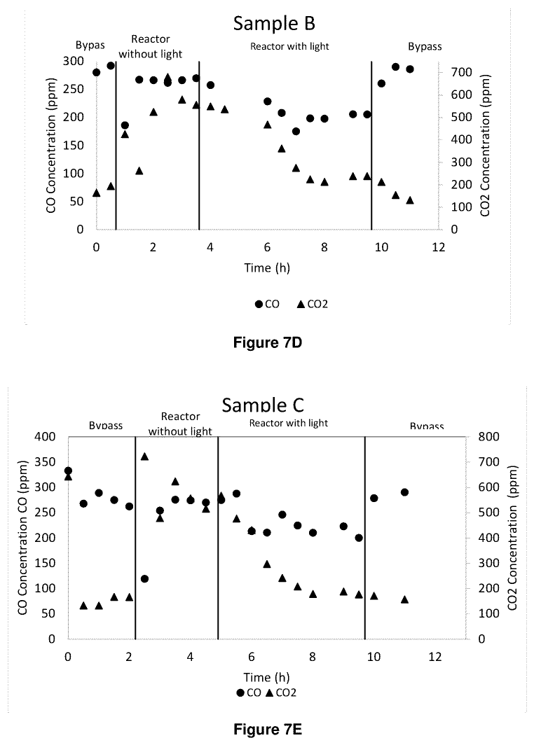

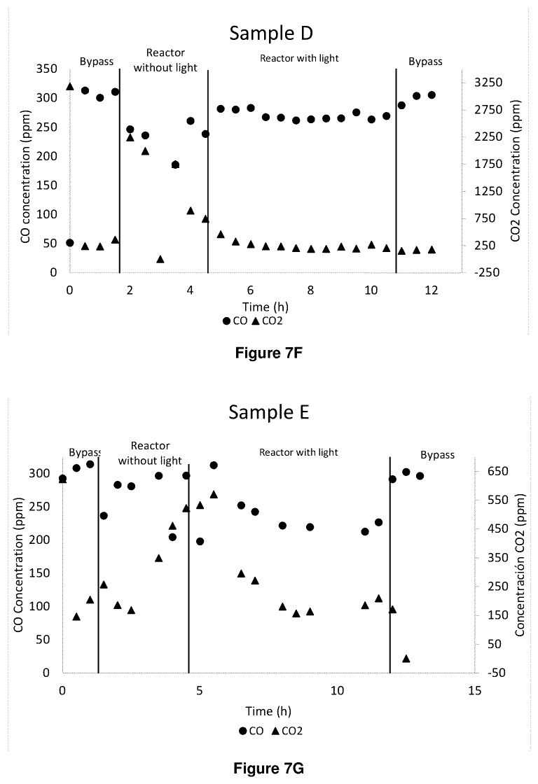

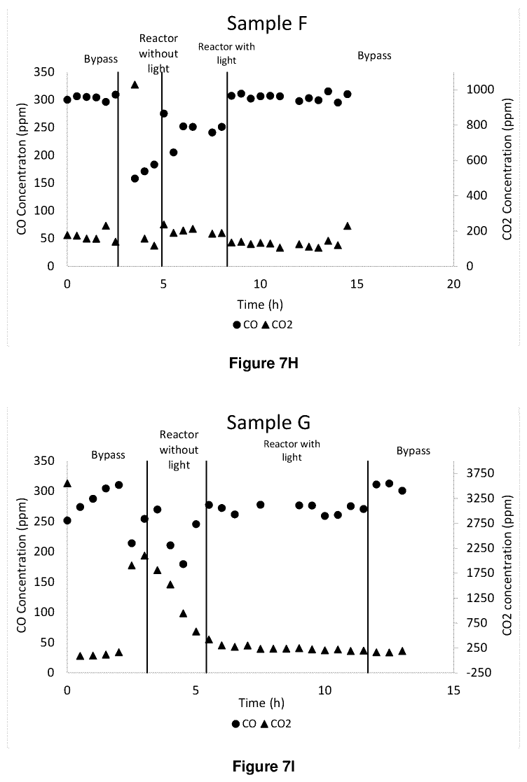

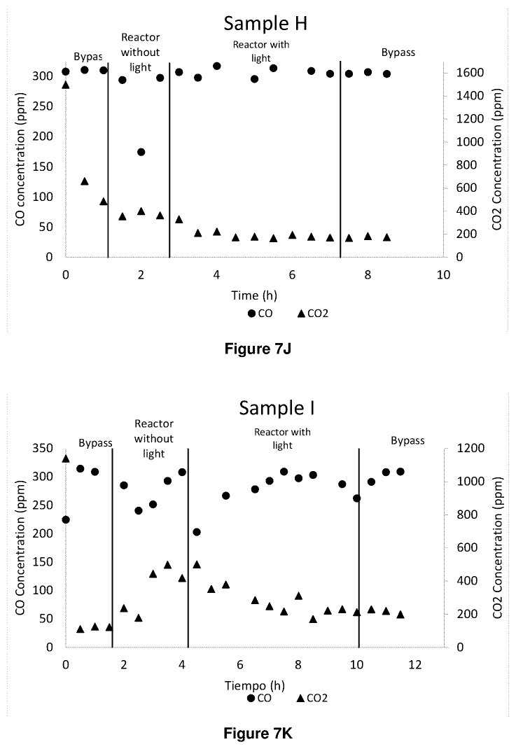

FIG. 5 shows as the CO concentration gradually decreases along to the reaction time. As opposed the CO₂ concentration increases along to the reaction time. However, CO₂ does not increase as much as CO decreases. In fact, the CO₂ increases is higher the CO decrease. Although after 4 hours CO₂ trends to decrease, suggesting—without adhering to any theory, that probably, a part of CO₂ could be being transformed to carbonate. FIG. 5 also shows that no stationary state is achieved by the reaction at the flow conditions.

FIG. 6 shows the results obtained in a second assay with 300 ppm CO and a total flow of 200 ml/min. it is noted that the passage of the mixture in the dark on the plates does not significantly reduce the CO concentration in the mixture, suggesting—without adhering to any theory, that such gas is not absorbed in the surface of the plates. After irradiation, it is observed that a decrease about of 42% relative to the mixture without irradiation. Also, it is noted that after 3 h of photoreaction a pseudo stationary state is achieved, which confirms that plates are photoactive, being consequent with the results of FIG. 5. On the other hand, in this Figure, it is observed that CO₂ was detected in the feeding mixture at dark conditions, which can be attributed—without adhering to any theory, to impurities (CO₂) at ppm level in the air mixture and/or CO₂ adsorbed in water. In spite of the above, the initial CO₂ concentration, in FIG. 6, it is observed a slight increase to CO₂ when the light is on, then the CO₂ concentration is significantly decreased. Such behavior suggests—without adhering to any theory, that probably a part of CO₂ is oxidized to carbonate as also suggested in the first test.

Thus, the photoreactor as designed, allowed a quantification of CO and CO₂ by means of plates being photocatalytically active to eliminate CO under irradiation of xenon bulbs.

Further, the photocatalytic capacity of 5 sets of plates with different concentrations of the present additive and other photocatalytic elements was tested. (Geometry of each plate: 9.5 cm×10 cm)

TABLE 5
Composition and content of samples used to validate

| Sample | A** | B** | C** | D** | E** |
|---|---|---|---|---|---|
| Content | The present | Photocatalytic compound 1 | Photocatalytic compound 1 | The present | The present |
| | additive (15% w/w) | (TiO₂) (15% w/w) | (TiO₂) + compound 2 (Cu) | additive (1% w/w) | additive (0.5% w/w) |
| | | | (15% w/w) | | |

Table 5 shows the initial mean concentration of CO during the bypass (BP) as well as the average concentration obtained once the conversion has stabilized (ON) per plate, CO₂ data is also added. Stabilization time was different per plate. Table 6 shows evolution per gas vs time as phase of reaction: bypass (flow does not pass through the photoreactor), OFF (flow passes through the photoreactor to “dark”), ON (photoreactor in operation).

TABLE 6
Conversion of CO and concentrations per sample

| Sample | A** | B** | C** | D** | E** |
|---|---|---|---|---|---|
| BP (CO) ppm | 299 | 305 | 304 | 306 | 308 |
| BP (CO₂) ppm | 169 | 175 | 143 | 214 | 277 |
| ON (CO) ppm | 168 | 238 | 248 | 231 | 266 |
| ON (CO₂) ppm | 187 | 190 | 147 | 330 | 216 |
| Conversion (%) | 44 | 22 | 19 | 25 | 14 |

Table 6 shows CO conversion calculated as final trend of a CO concentration (ON) using the following equation (Eq. 1):

$$Conversion ( \% ) = ( BP ( CO ) - ON ( CO ) ) / BP ( CO ) \times 100 \qquad Eq . 1$$

Thus, plate A ** showed a best CO conversion, A ** followed by plates D ** , E ** , B ** and C ** Specifically, plate having the present additive showed an advantage compared to plates having Photocatalytic compound 1 (TiO₂) and Photocatalytic compound 1 (TiO₂)+compound 2 (Cu). Further, plates having the present additive (1% w/w) shows a superior performance compared to the plates with the Photocatalytic compound 1 and Photocatalytic compound 1+compound 2 having a concentration 15-folds greater to the photocatalytic compound. Finally, a decrease in the oxidative capacity of the present additive vs concentration (0.5% w/w; 1% w/w and 15% w/w) was observed. Consequently, plates having the present additive are photocatalytically active to remove CO under Xenon lamp irradiation. In addition, the behavior to the CO₂ evolution suggests that a CO₂ oxidation to carbonate could have occurred.

### SO₂ Tests

Following the same methodology to CO, SO₂ tests were made.

TABLE 7
Composition and content of samples as used to validate.

| | A*** | B*** | C*** | D*** | E*** |
|---|---|---|---|---|---|
| Content | The present | Photocatalytic compound 1 | Photocatalytic compound 1 | The present | The present |
| | additive (15% w/w) | (TiO₂) (15% w/w) | (TiO₂) + compound 2 (Cu) | additive (1% w/w) | additive (0.5% w/w) |
| | | | (15% w/w) | | |

Table 7 shows the initial SO₂ concentration (average.) during bypass (BP) as well as the obtained SO₂ concentration (average) after stabilized the conversion (ON). Each plate shows a different time of stabilization. Table 8 shows the evolution per gas vs time as phase of reaction: bypass (flow does not pass through the photoreactor), OFF (flow passes through the photoreactor to “dark”), ON (photoreactor in operation).

TABLE 8
SO₂ conversion and concentrations per plate.

| Sample | A*** | B*** | C*** | D*** | E*** |
|---|---|---|---|---|---|
| BP (SO₂) ppm/min | 484 | 517 | 563 | 608 | 514 |
| ON (SO₂) ppm/min | 368 | 459 | 507 | 528 | 470 |
| Converted SO₂ ppm/min | 0.08 | 0.009 | 0.009 | 0.012 | 0.007 |
| Conversion (%) | 24% | 11% | 10% | 13% | 9% |

Table 8 also shows the SO₂ conversion calculated from a final trend to the SO₂ conversion (ON) used Eq. 1, but SO₂ instead of CO.

Thus, plates having the present additive are photocatalytically active to eliminate SO₂ under Xenon lamp irradiation. In addition, the behavior to the SO₂ evolution suggests that a SO₂ oxidation to SO₄⁻² and SO₃⁻² could have occurred.

### CH₄ Tests

Following the same methodology to CO, CH₄ tests were made.

TABLE 9
Composition and content of samples as used to validate.

| | A**** | B**** |
|---|---|---|
| Content | The present | The present |
| | additive (15% w/w) | additive (1% w/w) |

Table 9 shows the initial CH₄ concentration (average.) during bypass (BP) as well as the obtained CH₄ concentration (average) after stabilized the conversion (ON). Each plate shows a different time of stabilization. Table 10 shows the evolution per gas vs time as phase of reaction: bypass (flow does not pass through the photoreactor), OFF (flow passes through the photoreactor to “dark”), ON (photoreactor in operation).

TABLE 10
CH₄ conversion and concentrations per plate.

| Sample | A**** | B**** |
|---|---|---|
| BP (CH₄) ppm/min | 434 | 446 |
| ON (CH₄) ppm/min | 345 | 377 |
| Converted CH₄ | 89 | 69 |
| ppm/min | | |
| Conversion (%) | 21 | 15 |

Table 10 also shows the CH₄ conversion calculated from a final trend to the SO₂ conversion (ON) used Eq. 1, but CH₄ instead of CO.

Thus, plates having the present additive are photocatalytically active to eliminate CH₄ under Xenon lamp irradiation. In addition, the behavior to the CH₄ evolution suggests that there is a direct relationship between the amount of the present additive and the grade of conversion of CH₄.

### NH₃ Ttests

Essentially, following the same methodology to CO, NH₃ tests were made. But prior to the analysis, a reservoir consisting of an air-diluted contaminant mixture (app. 1000 ppm in air) was prepared. Total flow was 110 mL/min and passed through a saturator in a cryostat at 7° C., on which air is saturated at 6.5449 mm Hg-water, which in turns corresponds to 27.5% relative humidity at 25° C.

TABLE 11
Composition and content of samples as used to validate.

| | A***** | B***** | C***** | D***** | E***** |
|---|---|---|---|---|---|
| Con- | The | The | Photo- | Photo- | Photo- |
| tent | present | present | catalytic | catalytic | catalytic |
| | additive + | additive | compound 1 | compound 1 | compound 1 |
| | modifier | (1% w/w) | (TiO₂) | (TiO₂) + | (TiO₂) + |
| | (1% w/w) | | (15% w/w) | compound | compound |
| | | | | 2 (Cu) | 2 (ZnO) |
| | | | | (15% w/w) | (15% w/w) |

Table 11 shows the initial NH₃ concentration (average.) during bypass (BP) as well as the obtained NH₃ concentration (average) after stabilized the conversion (ON). Each plates show a different time of stabilization. Table 12 shows the evolution per gas vs time as phase of reaction: bypass (flow does not pass through the photoreactor), OFF (flow passes through the photoreactor to “dark”), ON (photoreactor in operation).

TABLE 12
NH₃ conversion and concentrations per plate.

| Sample | A***** | B***** | C***** | D***** | E***** |
|---|---|---|---|---|---|
| BP (NH₃) ppm/min | 1040 | 1006 | 787 | 799 | 1134 |
| ON (NH₃) ppm/min | 909 | 942 | 787 | 792 | 1123 |
| Converted NH₃ | 131 | 64 | 0 | 7 | 11 |
| ppm/min | | | | | |
| Conversion (%) | 13% | 6% | 0% | 1% | 1% |

Thus, plate A ***** is the most active in converting NH₃ while plate B ***** show the lowest conversion and no activity is showed by the remaining plates, consequently the present additive is photocatalytically active to eliminate NH₃ under Xenon lamp irradiation.

### Example 4: Optical and Electronic Properties and Band Gap (TAUC PLOT)

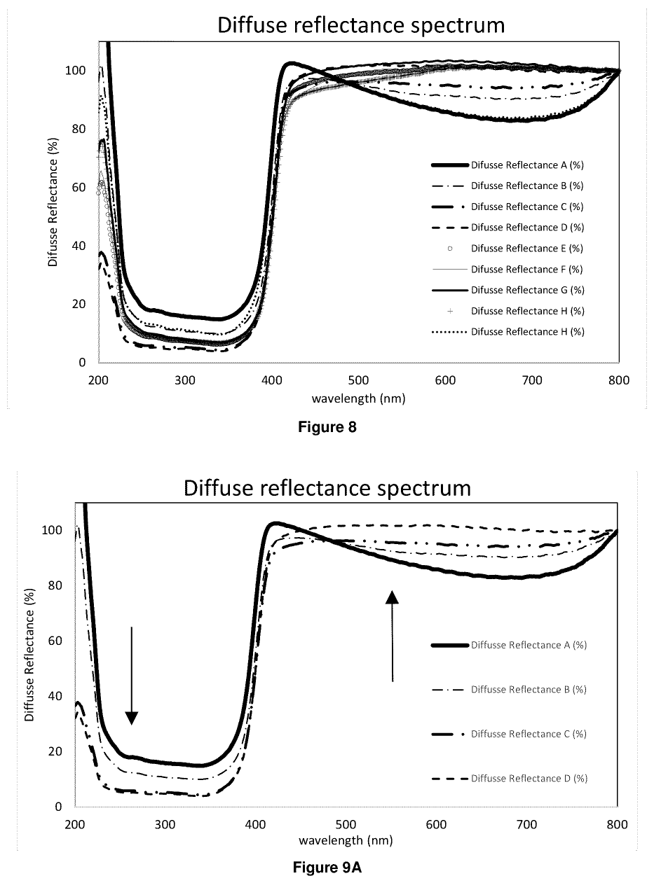

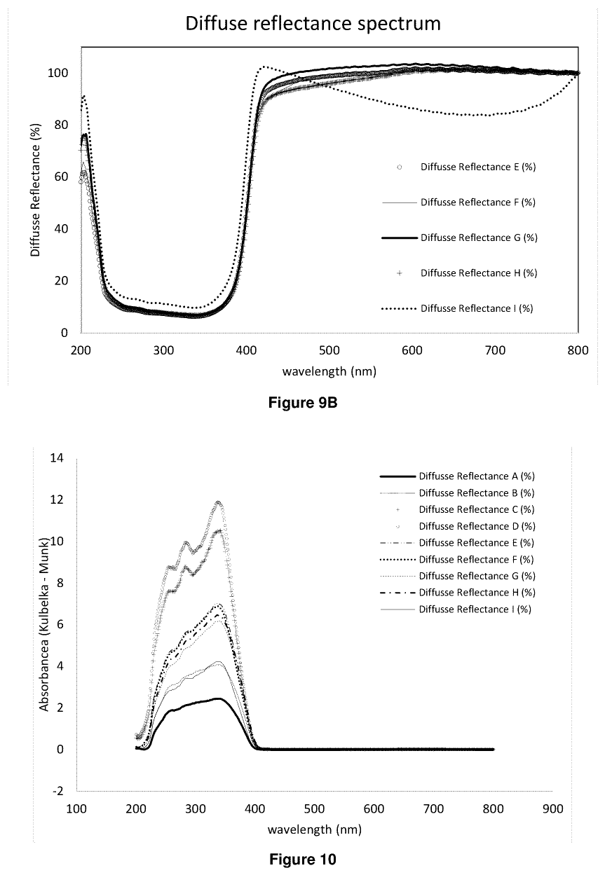

Solid samples A-I show a homogeneous absorption at the UV-vis zone, showing that the doping on the semiconductor is uniform and reproducible under optical terms. The diffuse reflectance (%) is determined as function of wavelength and after transformed to absorbance (Kubelka-Munk absorption). However, it is important remarking that the absorbance included the dispersion term since samples were not liquids, and thus, it could not be quantified. FIG. 8 shows the diffuse reflectance spectrum for each sample as function of wavelength (nm). Two bands were observed to A-D, one band is at the visible zone and another one is at the UV zone, attributed this last to a semiconductor, probably TiO₂. Sample A showed a higher intensity to the band at the visible zone, with respect to A>B>C>D, while at the UV zone, the band increases its absorption as follows A<B<C<D, which can result from a higher doped of sample A with respect to the remaining samples, and a less exposition results to the semiconductor.

Bands of samples E-H have a behavior different than the trend observed to samples A-D, although the two bands can be observed, the band at the visible zone is less intense and is displaced forward blue (app. 410-550 nm), being near to the absorption of the semiconductor, which can result from the amount or type of doping used.

Sample I is similar to sample A in terms of absorption bands. At visible zone, sample A showed a higher absorption than sample I, however, at the UV zone, the band of sample D showed a higher intensity of absorption than sample A. Thus, it can be expected that both samples can be the best candidate in terms of photocatalytic performance since they show a maximum absorbance in two zones, 390-240 nm and 650-410 nm.

Tauc method is a method widely used to determine of band gap (Eg) from the diffuse reflectance of a semiconductor solid sample. The following relational expression proposed by Tauc, Davis and Mott, has been used to determine a band gap or band gap between valence and conduction bands of a solid, allowing valuable information on the energy needed by a solid for exciting and/or activating itself after irradiated with light and obtaining a correlation of the photocatalytic behavior with electronic and optical properties determined as follows (Eq. 2):

$$( hv α ) 1 / n = A ( hv - Eg ) \qquad ( Eq . 2 )$$

wherein h: Planck constant, v: vibration frequency, a: absorption coefficient, Eg: prohibited band, A: constant proportional, n denotes the transitional nature of the sample. To a direct allowed transition, n is ½. To a direct prohibited transition, n is 3/2. To an indirect allowed transition, n is 2. To an indirect prohibited transition, n is 3. In the experiments, it was used an indirect allowed transition, thus n=2.

The acquired diffusive reflectance spectrum is converted to Kubelka-Munk function (Ec-3), allowing to generate a relation between the diffuse reflectance with absorption. This x-axis is converted in the amount F (R∞), which is proportional to the absorption coefficient. α in Eq. 2 is substituted by F (R∞). Thus, in the actual experiment, the expression relation is converted in (Eq. 3):

$$( hvF ( R ∞ ) ) 2 = A ( hv - Eg ) \qquad ( Eq . 3 )$$

Using the Kubelka-Munk function, the (hvF (R∞))2 was traced in function of hv. The curve tracing the value of (hv−(hvF (R∞))2) in the horizontal. It is drawn a hv-axis and the vertical axis (hvF (R∞))2. Thus, the unit to hv is in eV (electronvolts), and its relationship with wavelength λ (nm) is converted in hv=1239/λ.

A line tangential at the inflexion point to the above-mentioned curve is traced and the value hv at the intersectional point of the tangent line and horizontal axis is the value of the prohibited gap. These specters are showed in FIG. 10.

TABLE 13
Values if Eg (ev) determined from TAUC
method, with respective wavelength (nm).
Values obtained of the absorption graphs (K/S)
as function of energy (eV).

| Sample | Eg (eV) | λ (nm) |
|---|---|---|
| A | 3.05 | 406 |
| B | 3.02 | 410 |
| C | 3.00 | 413 |
| D | 3.00 | 413 |
| E | 2.99 | 414 |
| F | 2.98 | 416 |
| G | 2.99 | 414 |
| H | 2.97 | 417 |
| I | 3.05 | 406 |
| 1 (first sample) | 3.06 | 405 |

Table 13 shows values Eg (eV) with its respective wavelength of maximal adsorption, determined from the specters of FIG. 10. A slight change of Eq is observed from A (3.05 eV) to H (2.97eV), wherein there is a shifting of the electronic transition from BV to BC forward lower energies. This behavior can be attributed—without adhering to any theory, to the formation of a narrow binding between the semiconductor and the doping agent, evidencing a stable compound.

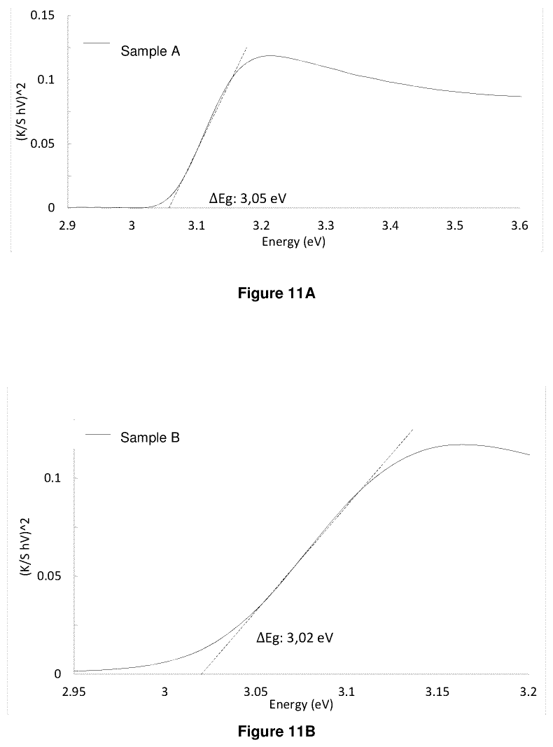

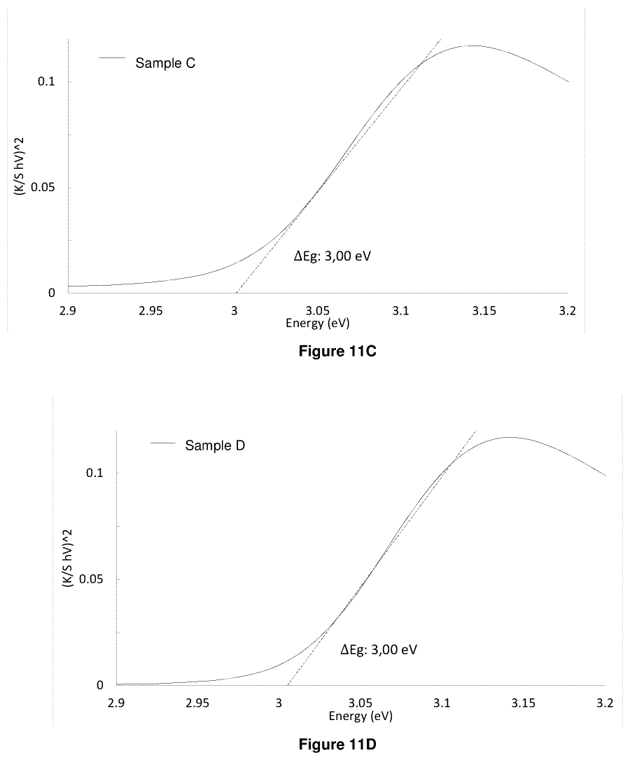

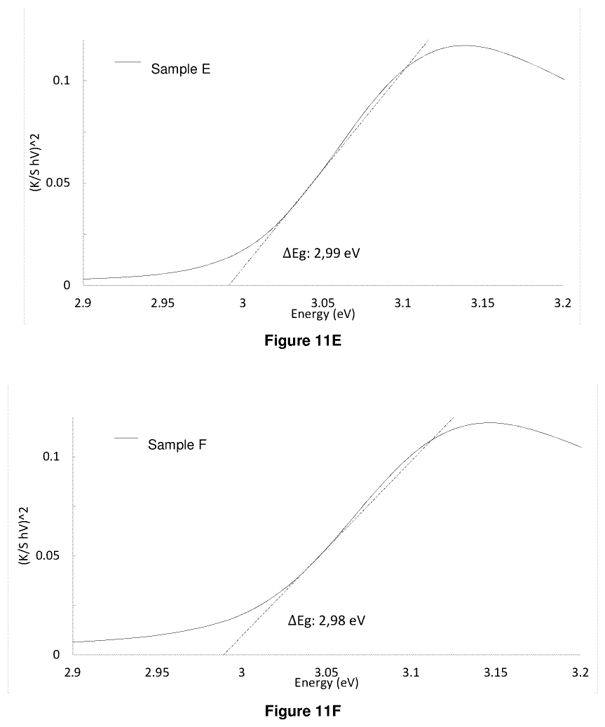

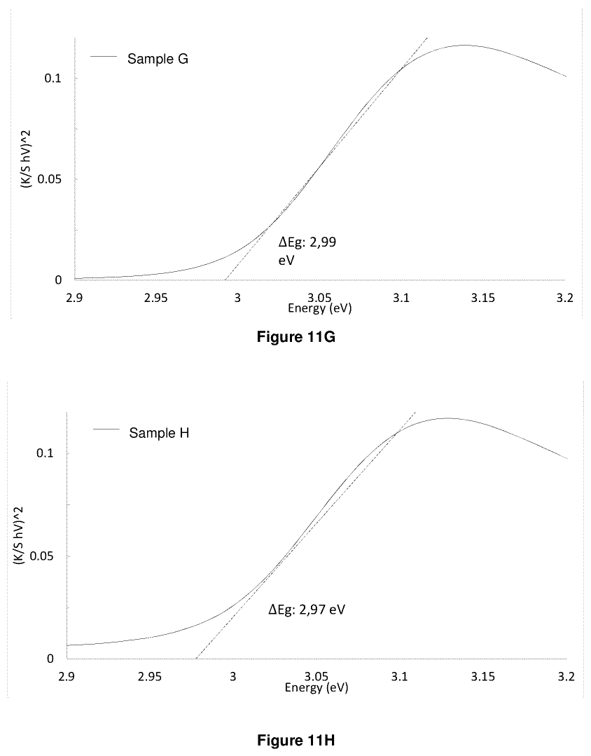

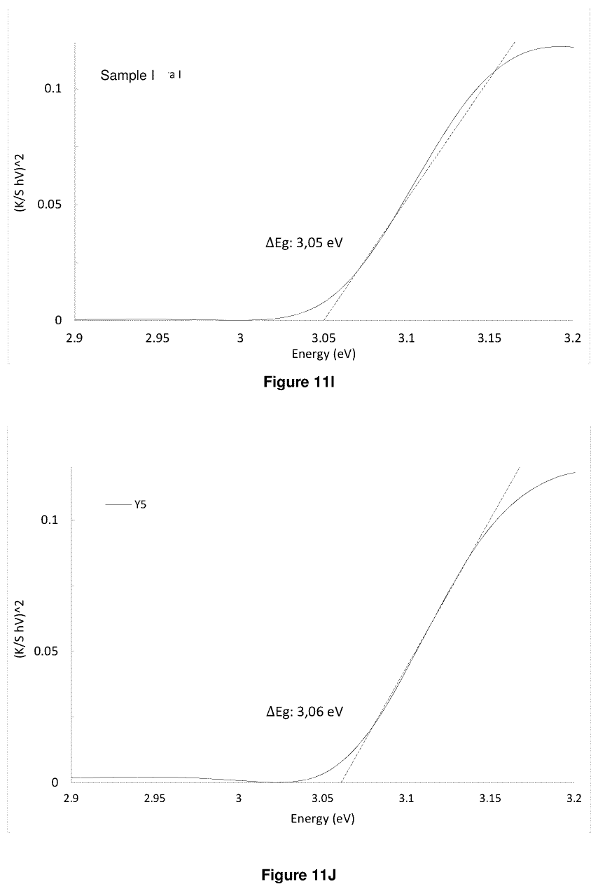

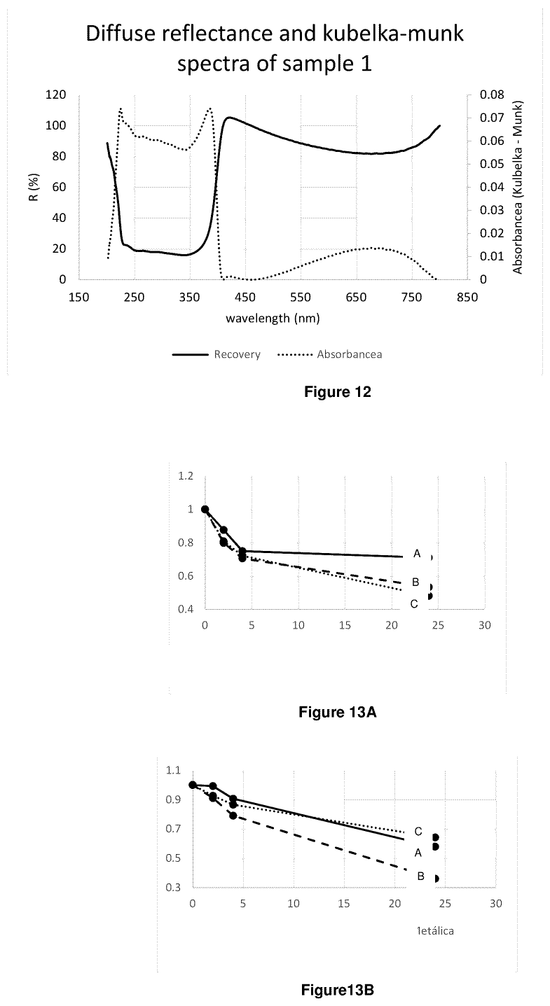

Additionally, it was added the value of the sample 1 which is 3.06 eV, which was the first measured sample. This sample is similar to sample A and I (see FIG. 11) regarding to its band gap and diffuse reflectance of bands (80% UV, 20% vis), thus it is expected a photocatalytic behavior similar to samples A and I.

To the correlation with photocatalytic activity, the trend of the plates in the CO conversion was 1>B>A>E>C, the remaining plates show a conversion lower 20%. While from the Eg analysis and from the visible region, samples 1, A and I should have shown the best performance. However, taken alone the intensity showed in the visible region a trend with the CO conversion could be found. Nevertheless, plate I shows a similar behavior to plate B, but this plate shows a low CO conversion.

Under electronic terms, the best samples are 1, A and I since the same present two higher intensity electronic transitions associated to the semiconductor (UV zone) and a doping at the visible zone. These transitions are associated to an energy of band gap allowing the higher quantity absorption of photons and to taking advantage of the visible zone between 770-400 nm. In optical terms, samples were stable and homogenous since a same absorption was showed in several zones. Also, it was evidenced the formation of a stable compound formed by a semiconductor of wide band gap ancho (3 eV) and a doping (probably metals) absorbing in the visible zone, generating a EG forward lower energy. This phenomenon favors the photocatalytic potential response.

Thus, the incorporation of CuO as 4^{th} metal oxide nanoparticle in the present decontaminant additive confers a necessary versatility to be activated with the visible light spectra between 400 and 770 nm added to the UV range, which does not occur when ZnO and/or TiO₂ are used as only photocatalysts.

The present decontaminant additive shows a synergistic behavior since the decontaminant and disinfectant effects of each metal oxide nanoparticle is not an effect merely additive.

When added a superplasticizer the behavior of the present decontaminant and disinfectant additive improves due to a dispersing effect caused to the metal oxide nanoparticles.

### Example 5: Evaluation of Photocatalytic Activity of Leather Inks

The present nanoparticle mixture in water together a polycarboxylate ether-based dispersant or another dispersant able to be associated in optimal way with leather inks can be used to evaluate photocatalytic activity. Three types of inks were assayed: 1.—White ink, which is based in water and applied by gun. 2.—Chic suede ink, which is based on alcohol and manually applied by sponge. 3.—Silver ink, which is based on a diluent and applied by gun. Table 14 shows the nine samples as assayed.

TABLE 14

| | | Concentration, % | | | |
|---|---|---|---|---|---|
| Name | Type | Control | 0.1% | 0.3% | 0.5% |
| White Ink | Eco-leather | X | X | X | |
| Chic suede | Krosta | X | | X | X |
| ink | (Natural | | | | |
| | leather) | | | | |
| Silver ink | Eco-leather | X | X | X | |

Methylene blue (AM) tests were made, wherein methylene blue strongly colored water at concentrations of a low milligrams per liter. This photocatalytic degradation has been reviewed by several researchers (Orendorz, A., Ziegler, C., & Gnaser, H. (2008). Photocatalytic decomposition of methylene blue and 4-chlorophenol on nanocrystalline TiO2 films under UV illumination: A ToF-SIMS study. In Applied Surface Science (Vol. 255, Issue 4, pp. 1011-1014). Elsevier BV. https://doi.org/10.1016/j.apsusc.2008.05.02; Mozia, S., Toyoda, M., Tsumura, T., Inagaki, M., & Morawski, A. W. (2007). Comparison of effectiveness of methylene blue decomposition using pristine and carbon-coated TiO2 in a photocatalytic membrane reactor. In Desalination (Vol. 212, Issues pp. 141-151). BV. 1-3, Elsevier 2)

https://doi.org/10.1016/j.desal.2006.10.007; 3) Houas, A. (2001). Photocatalytic degradation pathway of methylene blue in water. In Applied Catalysis B: Environmental (Vol. 31, Issue 2, pp. 145-157). Elsevier BV. https://doi.org/10.1016/s0926-3373(00)00276-9) and its Langmuir-Hinshelwood photocatalytic degradation kinetic is known. Methylene blue has a molecular formula C₁₆H₁₈N₃SCI (M. W.=320.87g/g-mol).

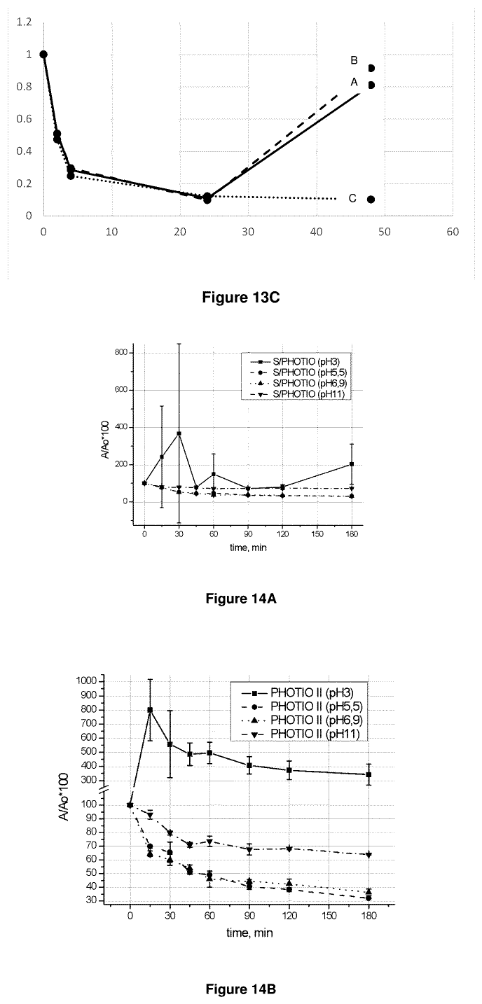

Table 15 summarizes the photocatalytic activity of samples. Films were fixed in Petri plates and then a methylene blue solution (0.02 mM) was added. Specifically, 25 mL of solution was added on a labelled Petri plate. Methylene blue absorbance was evaluated as well as its dark evolution wherein UV radiation was avoided, and an evaluation was also made after applied external agents to superficial phenomena as adsorption/absorption. Assays were made by triplicate and to UV-visible measurements 96-well plates were used. Also, micropipettes 20-200 μL and an indoor dark chamber were used. Dark period was evaluated in two ways. A first way based on 3 points, initially, 1 hour later and 16 hours after in darkness. A second way comprising three hours of continuous measurements and sampling at 0, 10, 20, 30, 40, 50, 60, 90, 120, 150 and 180 minutes. After achieved the highest methylene blue absorption by leather, 25 ml of methylene blue solution (0.02 mM), which has been previously prepared, is added to each plate. An initial value of absorbance is measured, and then plates are irradiated. Measurements are taken under the following irradiation times 0, 2, 4 and 24 hours. Graphs are made from the results to contrast differences between control and different concentrations. FIGS. 13A-13C are showing the results of methylene blue degradation to white ink, metal ink and paint in leather (Krosta).

A best result (51% blue methylene degradation) occurred to the present mixture (0.3%) to white ink in eco-leather. Degradation decreases up to 46% at 0.1% while a degradation of 28% is achieved by control. Similarly, a best result (61% blue methylene degradation) occurred to the present mixture (0.1%) to metal ink in eco-leather. On the other hand, there are high rates of absorption and desorption to alcohol-based inks in Krosta leather, and not different kinetic between control and the present mixture (0.3% or 0.5%) can be observed at 24 hrs and only a highest degradation of 10% was achieved after 48 hrs, a desorption was observed at 0.3% and a continuous absorption increase was observed at 0.3%.

### Example 6: Colorant Degradation in Presence of The Present Mixture and An Adhesive/Sealant

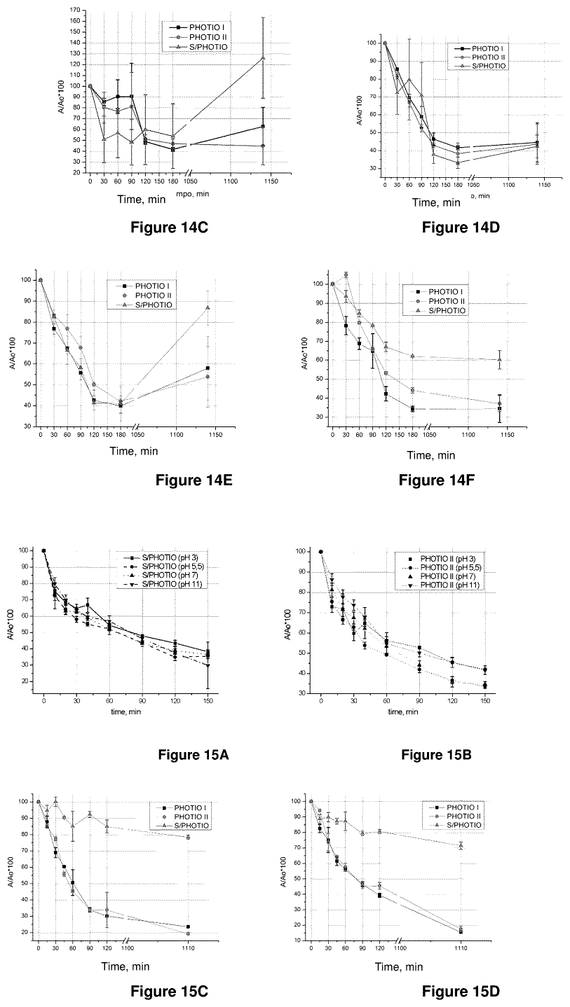

The present nanoparticles mixture in water together a polycarboxylate ether-based dispersant or another dispersant able to be associated in optimal way with leather inks can be used. Adhesive/sealant is matte-shade water-based varnish. Two forms of addition are used. A first form comprising water diluted adhesive/sealant (50% water-50% Adhesive/Sealant) and then a powder of the present mixture is added. Subsequently a mixture is prepared by mechanically stirring (blade mechanical stirring) at 2000 rpm up to achieve a homogeneous paste. A second way comprising taking an adhesive/sealant mass to combine it with the present mixture in a dispersion at 20% to easily obtain a mixture, wherein both, adhesive/sealant and the present mixture, are present under aqueous base, which can also facilitate preparing samples having smaller sizes. FIG. 14 shows adhesive/sealant as Control 1; 50% water/50% adhesive/sealant as Control 2. To the present mixture, powder samples (1%) was prepared. After the present mixture (20%) is mixed with adhesive/sealant by dispersion under the following concentrations: 5, 10, 15 and 25%. 1 or 2,5 grams of samples were taken to be fixed in Petri plates to evaluate methylene blue degradation.

### Rose Bengal Dye

Rose bengal dye, which belongs to xanthene family due to a central xanthene group and aromatic groups acting as chromophores, classifies as a photosensitive, anionic, water-soluble, organic dye. It is broadly used in fabric and photochemical industry, and is toxic, can cause irritation, itch, and even blisters on the skin, and also can attack epithelia of human cornea (V. C. et al./Environmental Nanotechnology, Monitoring & Management 6 (2016) 134-138, J. Kaur, S. Singhal/Physica B 450 (2014) 49-53, B. Malini, G. Allen Gnana Raj/Journal of Environmental Chemical Engineering 6 (2018) 5763-5770). The same has C₂₀H₄Cl₄l₄O₅ as molecular formula and a molecular formula as showed by Structure 1 below. Its maximum absorption length wave is 550 nm, which is used to determine the absorption capacity and photo-degradation of each plate.

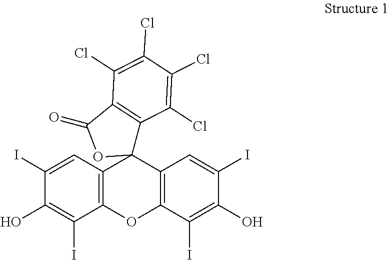 [SMILES: O=C1OC2(c3cc(I)c(O)c(I)c3Oc3c2cc(I)c(O)c3I)c2c(Cl)c(Cl)c(Cl)c(Cl)c21]

A stock sample 5 mM was evaluated from which diluted solutions 0.02 mM were prepared with water type I. Colorant degradation in Petri plates was evaluated with 2.5 grams of the present mixture (1%) in adhesive/sealant (50% water). These plates were conditioned with 20 mL of colorant solution and then the absorption and degradation under UVC radiation were evaluated.

Specifically, 1 gram of the present invention (powder) is added to 99 grams of a water-diluted adhesive/sealant, and then, mixed with an agitator up to obtain a homogenous color. Resulting mixture is not totally stable, and then, the same should be reagitated prior to be used. A second mixture is prepared to only water-diluted adhesive/sealant as control. Samples are dried for 12 to 24 hours, and then, submitted to a conditioning procedure where 20 ml of a rose Bengal solution (0.02 mM) is added after which samples are ready to the absorbance variation assays.

Graphs absorbance (A/Ao*100) vs dark interaction time for 180 minutes. After absorption time, and UVC-light degradation starts samples were taken from stirred plates and 3 wells per each plate were used. Different pH values to the solution 0.02 mM, were used. Such pH values are as follows: 3, 5.5, 6.9 and 11. This allows the evaluation of the modified matrix interaction. Present mixture was evaluated and reported by duplicate as Photio I and Photio II.

FIGS. 14A and 14B show absorption results and FIGS. 14C-14F show the photo-degradation of rose Bengal colorant in an adhesive/sealant matrix modified at different pH values. At pH 3, both figures, FIG. 14A and FIG. 14B, show a high error in the absorbance measurement, which could be caused by a spontaneous discoloring of the solution. At pH 11, with or free of the present additive, a low colorant absorbance was observed. FIGS. 14C-14F shows the Rose Bengal photo-degradation at pH values of 3.0, 5.5, 6.9 and 11 with or free of the present additive (Photio I and Photio II).

At pHs 3 and 11, the best performance of the present additive was obtained. A high absorbance reduction is observed after 180 minutes (46±5% and 44±1%, respectively). Free of the present additive, the absorbance is 53±30% and 62±1% to the same pH values (3 and 11, respectively). But a better degradation occurs at pH 5.5 (free of the present additive), wherein the absorbance decreases at 33±3% after 180 minutes while with the present additive absorbance such percent is 38±6%, with respect to the initial absorbance.

Thus, rose Bengal dye has an unreproducible behavior since the same decoloring and coloring after applied UVC radiation, which originates significant errors in the measurements, specially, in absence of the present additive. However, it could be concluded that at pH 3 main errors were observed since a spontaneous coloring and discoloring occurs, specially at the first 15-30 minutes wherein absorbance values are 10-folds to the initial values. Similarly, at pH 11 to both samples a lower absorption of colorant is observed, thus, there would be a lower interaction matrix-colorant. On the other hand, at pH 5.5 lower degradation values were obtained, with and free of the present additive, but measurements are overlapped due to the level of error and then there is no significant different therebetween. Also, at pH 3 and 6.9 the absorbance to samples free of the present additive, returns to original values after a prolongated exposition to radiation while at pH 5.5 and 11 the absorbance is kept or slightly increased. Thus, after added the present additive, the initial absorbance cannot be reinstated and at pH 3 and 11, degradation slightly increases and at pH 6.9 degradation trends to an increasing slightly superior. Thus, no photocatalytic effect can be strongly observed but it corresponds to a photosensitive colorant and UVC radiation can be very intense and can generate major variations in a response. At pH 11 there is a lower interaction matrix-colorant and a better degradation with the present additive along to the exposure time.

### Methylene Blue Ink

Methylene blue (AM) intensely coloring water with a few milligrams per liter. AM degradation by photocatalysis has been reviewed by several researchers (Orendorz, A., Ziegler, C., & Gnaser, H. (2008). Photocatalytic decomposition of methylene blue and 4-chlorophenol on nanocrystalline TiO2 films under UV illumination: A ToF-SIMS study. In Applied Surface Science (Vol. 255, Issue 4, pp. 1011-1014). Elsevier BV. https://doi.org/10.1016/j.apsusc.2008.05.023; Mozia, S., Toyoda, M., Tsumura, T., Inagaki, M., & Morawski, A. W. (2007). Comparison of effectiveness of methylene blue decomposition using pristine and carbon-coated TiO2 in a photocatalytic membrane reactor. In Desalination (Vol. 212, Issues 1-3, pp. 141-151). Elsevier BV. https://doi.org/10.1016/j.desal.2006.10.007; Houas, A. (2001). Photocatalytic degradation pathway of methylene blue in water. In Applied Catalysis B: Environmental (Vol. 31, Issue 2, pp. 145-157). Elsevier BV), exhibiting a Langmuir-Hinshelwood-type photocatalytic degradation kinetic. AM has C₁₆H₁₈N₃SCI (M. W.=320.87g/g-mol) as formula, and its structural formula is showed in Structure 2 below. AM has 664 nm as maximum absorption length wave, which is used as reference to determine the absorption capacity and photo-degradation in plates.

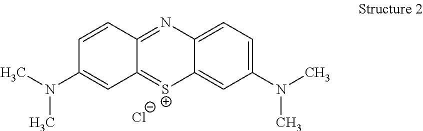

Degradation was evaluated in Petri plates having 2.5 grams of the present additive (1%) in Mod Pogde (50% water). Plates were conditioned with 20 mL colorant solution and then colorant absorption and degradation under a UVC radiation were evaluated. Firstly, the present additive (1%) in water-diluted Mod Podege (50%) was prepared from a mixture of 1 gram of the present additive (powder) and 99 grams of water-diluted adhesive/sealant, stirring up to obtain a homogeneous color, which is not totally stable. Secondly, a second mixture is prepared from only water-diluted adhesive/sealant and used as control matrix. After 12 to 24 hours of drying, samples are submitted to a conditioning procedure in which 20 ml of methylene blue (0.02 mM) is added, subsequently absorbance variation is evaluated. Absorbance (A/Ao*100) vs darkness interaction time graphs was firstly obtained for 180 minutes. After started UVC-light degradation and always previously agitating plates, samples were taken, 3 wells per plate were used. These steps are carried out at different pH values of solution 0.02 mM, this is, pH 3, 5.5, 6.9 and 11, to evaluate the interaction with the modified matrix. Two results are always provided (Photio I and Photio II) for the plates with the present additive.

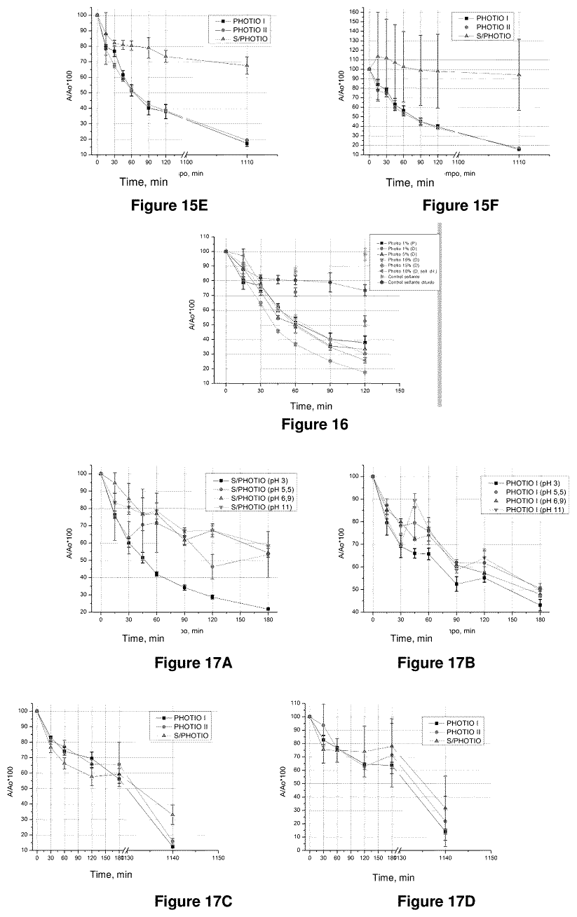

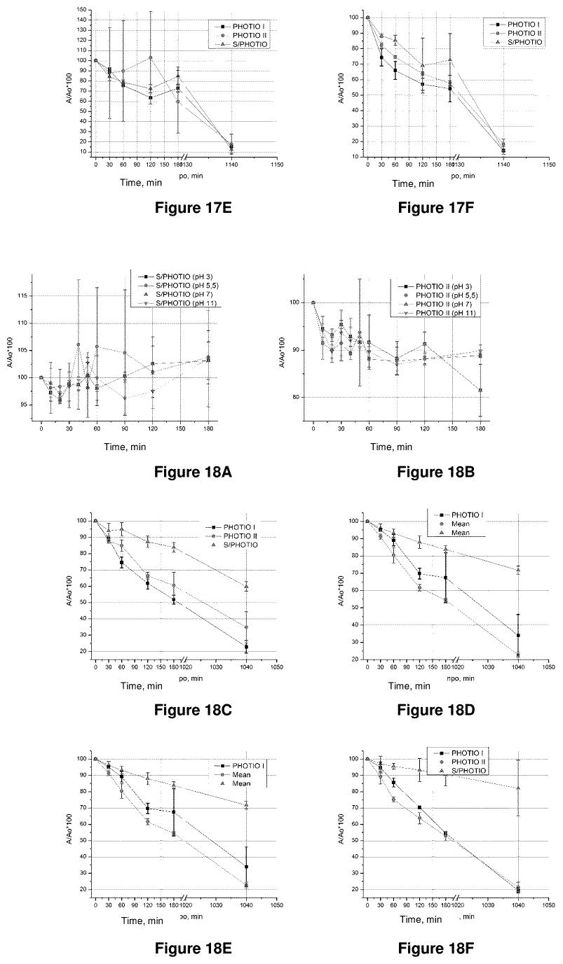

FIGS. 15A-15F and 16 are showing the absorbance results to methylene blue and table 4 is showing the photo-degradation results of methylene blue in a modified matrix of adhesive/sealant at different pH values. As can see from figures, all the pH's assays show a decoupled behavior in relation to a control plate, which evidence a photocatalytic activity when the present additive is added. Also, results are reproducible since both preparations (Photio I and Photio II) showed similar results and a low error.

No remarked effect is observed to the absorption process depending on pH changes or presence or absence of the present additive. Thus, the kinetic of absorption could not be dependent from these components and exclusively depending on the initial colorant concentration, which in turn is coincident with preliminary experiments wherein a pseudo-first order kinetic was evidenced to adhesive/sealant and the present additive mixtures in relation to methylene blue colorant.

At pH 3, a sudden degradation is observed in presence of the present additive, which evidences a photocatalyzed decomposition reaction at 90 minutes of UVC radiation when the initial absorbance is reduced at 33%. At pH 11 a major reduction of the initial absorbance is observed, a reduction of app. 16%, however this value is relatively similar to the ones obtained at pH 5.5 and pH 7. To the control a similar degradation is obtained at pH 3-5, 5-7 (65-80% of the initial absorbance) and at pH 11 an erratic behavior is present having major variations to the recorded values which did not allow a major analysis.

At 120 minutes, degradation results and curves of the graphs are showing a plate taking 10-folds more of time to achieve a similar degradation value, compared to the modified adhesive/sealant (1%). The initial absorbance (decoloring) is reduced up to 30% while being free of the present additive, degradation values did not achieve 75% for a same time.

FIG. 16 compares the present additive having higher concentrations and made from a commercial dispersion. A dispersion mixture (10%) in the adhesive/sealant (not diluted) shows a best response since initial absorbance was reduced up to 17% in 2 hours while the present additive (1%) achieves a reduction only up to app. 35%. But no direct relation is confirmed between degradation and concentration of the present additive since samples having 5-15% concentration achieves a degradation which is not significantly different to the ones of samples having a 1% concentration. Further, at 1% of concentration, a low degradation is for samples made from a dispersion compared to the ones made from powder, which could result since a powder mixture could have achieved a best homogeneous mixture due to the stirring while a dispersion - although can be easier to mix, could be affected by a viscosity change to the adhesive/sealant matrix as difference of the aqueous medium in which originally the same is present.

### Rhodamine B, UV-VIS

Rhodamine B is a xanthene amino derivative widely used as colorant in the fabric and paper industries, to prepare fluorescent pigments and a current tracer to water contamination studies, etc. But the same is more extensively used in analytic chemistry fields as colorimetric reagent and fluorometer for a variety of chemical species. Empirical formula is C₂₈H₃₁ClN₂O₃. Structural formula is showed in structure 3. At 554 nm, this colorant has a maximum absorption length wave, which was used as reference to determine the absorption and photo-degradation capability of plates.

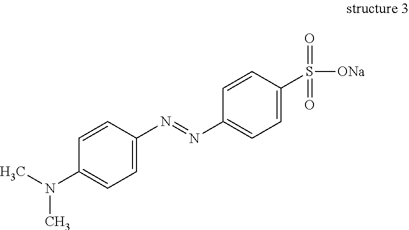

A stock sample 5 nM was prepared, from which diluted solutions 0.02 mM were prepared with water type I. Colorant degradation was evaluated in Petri plate with 2.5 grams of the present additive in Mod Pogde (50% water). Plates were conditioned with 20 mL of colorant solution and then colorant absorption and degradation under UVC radiation was evaluated. Firstly, the present additive (1%) in water-diluted Mod Podege (50%) is prepared from 1 gram of the present additive (powder)+99 grams water-diluted adhesive/sealant and mixed by stirring up to obtain a homogeneous color, which is not totally stable. Secondly, a mixture of only water-diluted adhesive/sealant is also prepared as control matrix. Samples are dried for 12 to 24 hours, and such dried samples are submitted to conditioning by adding 20 mL rose Bengal solution (0.02 mM). Subsequently, the absorbance variation is evaluated. Absorbance (A/Ao*100) vs darkness interaction time graphs for 180 minutes, are obtained. After a UVC-light degradation starts, samples were taken from stirred plates and using three wells per each plate along to the experiment avoiding error by a change of well. These steps are carried out with different pH values to the solution 0.02 mM. pH values are as follows: 3, 5.5, 6.9 and 11. The above to evaluate the interaction with the modified matrix. Further, plates with the present additive are duplicated then two results are always provided (Photio I and Photio II),

To both absorption cases, a significant error is observed in the measurements with exception of pH 3 wherein an absorption trend similar to the ones of the prior reported colorants is observed, which could be caused by the incidence of pH in the absorption kinetic of the compound wherein the same could be a relevant parameter.

From these results no major difference was observed in degradation by the presence of the photocatalyst according to these graphs a strong interaction with UVC light was registered and there is no evidence of a photocatalyst presence.

Rhodamine B colorant was evaluated according to the methodology described above by adhesive/sealant plates containing 2.5 grams of modified and non-modified matrix. Colorant was evaluated at 0.02 mM of concentration at pH 3-5.5-7-11 to evaluate its degradation in relation to this parameter, wherein the best absorption and degradation results were observed at pH 3. No clear trend is observed to the behavior the exposed samples wherein the error in the absorbance measurement decreases and a curve similar to the colorants described above which is clearly showed in sample without the present additive. While samples having the present additive are trending to form two plates of equilibrium, a first plate of equilibrium between 30-60 min and a second plate between 90-180 min. Thus, the presence of the catalyst pH does not significantly alter the curve since these two plates are evidenced with certain resolution in all the cases, which means that the absorption kinetic depends on certain grade of the photocatalyst presence.

Also, it is observed that both samples can degrade the compound with a greater time of irradiation, which means that the set of measurements no difference is achieved to a catalytic procedure of degradation, which is not depending on pH, with the only exception of pH 3. At pH 3 a lower error is observed in the measurement and a clear difference is observed in samples containing the present additive versus a control sample, and a reduction of app. 15% to the initial absorbance compared to a reduction no greater 25% to the control sample. This low difference could be caused by a fast kinetic of the rhodamine B degradation under UVC light, and the use of lamps having lower energy as UVA, xenon or even sunlight could be used to better differentiate a photodegradation in presence of the photocatalyst.

### Methyl Orange, UV-VIS

Methyl Orange is used as ink, fabric printing and paper industries. Methyl Orange is a water-soluble synthetic aromatic compound having an azo group as chromophore, which is toxic and can cause hyper sensibility, allergies and even lethal after inhaled. Structure 4 shows a structural formula. This compound has a maximum absorption length wave of 465 nm, which is used as reference to determine the absorption and photo-degradation capability of plates with adhesive/sealant and the present additive.

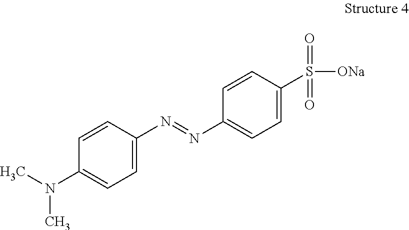

A stock sample 5 mM was evaluated which was prepared from diluted solutions 0.02 mM, prepared with water type I. Colorant degradation was evaluated in Petri Plates with 2.5 grams of the present additive (1%) in Mod Pogde (50% water) these plates were conditioned with 20 mL colorant solution and then colorant absorption and degradation under UVC radiation were evaluated. Firstly, a first mixture of the present additive (1%) in water-diluted Mod Podege (50%) is prepared, from 1 gram powder of the present additive+99 grams water-diluted adhesive/sealant, which is stirred up to obtain a homogeneous color, which is not totally stable and then the same should be stirred prior to use. Secondly, a second mixture of only water-diluted adhesive/sealant is prepared as control matrix. Samples are dried for 12 to 24 hours, and after 20 ml of methyl orange (0.02 mM) is added to start the conditioning procedure. After conditioned the absorbance variation was evaluated in the conditioned samples. Firstly, an absorbance graph (A/Ao*100) vs darkness interaction time for 180 minutes is obtained. After a degradation with UVC light is started, always stirring prior to take the samples and using three wells per each plate along to the experiment avoiding error per change of well. These steps are carried out at different pHs of solution 0.02 mM, which are as follows: 3; 5.5; 6.9 and 11. This is to be able to evaluate the interaction with the modified matrix. Further, to plates with the present additive, duplicated results are provided (Photio I and Photio II).

To both absorption cases, a significant error in the measurement is observed and no clear trend can be distinguished even after added the present additive since plate was achieved at 10 min but error is closer to initial absorbance values. From these results the presence of the present additive is distinguished, acting as a photocatalyst in the orange methyl degradation at different pHs, further, at pH 11 a lower error in the measurement is observed and a greater degradation of initial absorbance, achieving a reduction up to app. 20%. Further, at pH 3-5.5 and 7 a plate between 120-180 minutes is achieved and overcome after 1040 minutes.

Methyl Orange colorant was evaluated as described above by adhesive/sealant in plates containing 2.5 grams of the modified and non-modified matrix. Colorant was evaluated at 0.02 mM of concentration and pH 3-5.5-7-11 to evaluate degradation in relation to this parameter, wherein the best results are observed at pH 11 to degradation but to absorbance no significant difference was observed in the analyzed samples.

In the absorption case there is a no clear trend in the behavior exposed by samples either in absence or presence of the present additive and the measurement error turns hard the analysis of the process. Thus, the presence of a catalyst is observed a plate from 10 minutes to 120 minutes, wherein the absorption continuing at pH 7 while to the other pH is kept. To degradation, the presence of the present additive turns the reaction very much faster, in 60 minutes a separation to the degradation occurs in relation to control group and app. 50% is degraded in 180 minutes (compared to initial absorbance). Similarly at pH 11 samples having the present additive continue a lineal degradation along to the experiment while at pH 3-5.5 and 7 Plato is achieved in 180 minutes and after a degradation up to 20 to 40% is achieved. The presence of the present additive in the photodegradation of methyl orange effectively catalyzes the reaction while a sample without catalyst reduce the initial absorbance at 85% in presence of the present additive with independence of pH values achieving app. 50-70%, which is better at pH 11.

### Example 7: Photocatalytic Behavior of a Mixture With The Present Additive and a White Color Water-Based Cured Compound (Sika® Antisol®) in Concrete

The present additive is a nanoparticle mixture in water together with a polycarboxylate ether-based dispersant, which can be optimally associated to a final product. In this case, such final product is a water-based cured compound, which to be pulverized on fresh concrete can be adhered to the surface of this forming a film impervious to water and air, avoiding evaporation of gauging water and premature drying of concrete by sun and wind effects.

After an optimization process, the best preparation corresponds to samples elaborated in vortex with addition of ionic surfactants, which is as follows: 20 g Sika® Antisol® is added to a Falcon tube (50 ml) and further 0.25 g CTAB and 0.25 g SDS (dilutions at 10%), which is carried out to vortex and then agitated at a lower velocity for 1 min to take a recess of 3 min to start a new stirring for 1 additional min. Then, 1.05 g the present additive (20%) is added, and the vortex procedure is repeated once.

Thus, control samples are powdered pre-manufactured cement with Sika® Antisol®. Sample 1: powdered pre-manufactured cement with Sika® Antisol® +the present additive (Preparation according to the description above).

### Methylene Blue Degradation Tests, Colorimetry

Methylene Blue degradation was evaluated in the surface of concrete under UVC light. AM degradation is measured as a change of color along to time. A PCE XXM30 colorimeter is used, which can determine color in the following color spaces: CIE-LAB, CIE-LCh, HunterLab, CIE-Luv, XYZ, RGB, and has a LED having a length wave between 400-700 nm as light source.

Colorimeter opening has a diameter of 8 mm and has a repeatability of ΔE*ab≤0.1. From the available space colors, CIE-LAB was used and represents a quantitative color ratio in three axis: “L” values means luminosity, and “a” and “b” mean coordinates of chromaticity. In color diagram, “L” represents a vertical axis having values of 0 (black) to 100 (white). Value “a” means red-green component in a color, where +a (positive) and −a (negative) means red and green values, respectively. Yellow and blue components are represented in axis b as +b (positive) values and −b (negative) values, respectively. The core is neutral or achromatic. The distance from the central axis represents the chrome (C*) or the color saturation. Angle over the chromaticity axis represents hue (h).

2 samples of pre-manufactured cement are prepared, one of them is containing the present additive+Sika® Antisol®, and the other one is containing only Sika® Antisol® as control sample. The present additive+Sika® Antisol® is applied by a sprinkler on a concrete surface. Container should be shaken prior to be applied and further sieved with a fine mesh to remove lumps which can obstruct the spraying nozzles and applied on the surface of fresh concrete once it achieves a superficial opaque shade, i.e., when the excess of gauging water (exudation) is evaporated, time can vary between half and two hours after ended its installation, depending on wind and room temperature. Similarly, a second mixture is prepared, and only Sika® Antisol® is applied by a sprinkler on the cement surface. Samples are dried for 3 hours, then the same are dyed with methylene blue (0.02 mM) at pH˜7 and dried for 15 minutes. Once dried the samples parameters L, a and b are measured with a colorimeter. Further, samples are introduced in degradation UVC chambers. Distance between samples and lamps is 8 cm. Colors are registered in times 0, 2, 5, 24, and 100 hours.

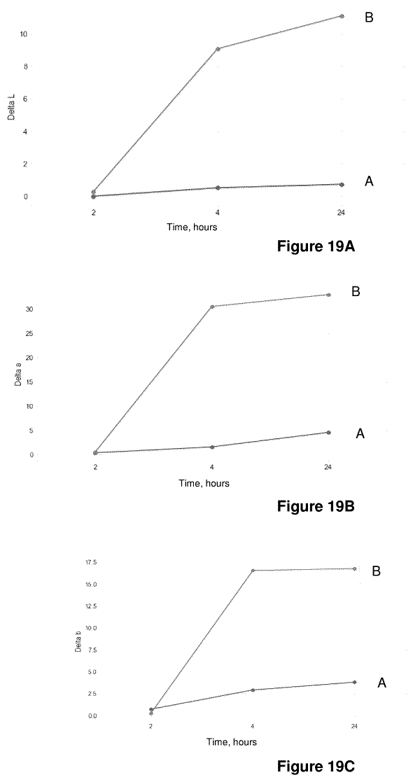

Table 15 shows the results of variation to parameters L, a and b, for samples with o free of the present additive after 2, 4 and 24 hours. FIGS. 19A-19C shows the colorimetric graph results in AM degradation in cement with Sika® Antisol® with and free of the present additive. Table 15 shows the related measurements.

TABLE 15
Colorimeter results - AM Degradation in cement with Sika ®
Antisol ® with and free of the present additive

| | | Delta 2 | Delta 4 | Delta 24 |
|---|---|---|---|---|
| Samples | Parameter | hours | hours | hours |
| Control (Sika ® Antisol ®) | L | 0.03 | 0.49 | 0.70 |
| | A | 0.29 | 1.51 | 4.50 |
| | B | 0.68 | 2.88 | 3.77 |
| Sample 1 (Sika ® | L | 0.25 | 9.07 | 11.10 |
| Antisol ® + | A | 0.46 | 30.48 | 32.94 |
| present additive) | B | 0.23 | 16.52 | 16.75 |

TABLE 16

| T = 0 | L | A | B | T = 0 | L | A | B |
|---|---|---|---|---|---|---|---|
| Control | 50.32 | −6.74 | −10.64 | Sample 1 (Sika ® | 37.58 | 19.93 | 0.98 |
| (Sika ® | 50.06 | −8.77 | −5.55 | Antisol ® + the | 37.93 | 20.05 | 0.9 |
| Antisol ®) | 50.27 | −7.28 | −9.57 | present additive) | 39.52 | 15.68 | 3.09 |
| Average | 50.22 | −7.60 | −8.59 | Average | 38.34 | 18.55 | 1.66 |
| STD | 0.14 | 1.05 | 2.68 | STD | 1.03 | 2.49 | 1.24 |
| T = 2 hours | L. | A | B | T = 2 hours | L | A | B |
| Control | 50.06 | −8.77 | −5.55 | Muestra 1 (Sika ® | 37.93 | 20.05 | 0.9 |
| (Sika ® | 50.27 | −7.28 | −9.57 | Antisol ® + the | 39.52 | 15.68 | 3.09 |
| Antisol ®) | 50.17 | −8.03 | −7.56 | present additive) | 38.73 | 17.87 | 2.00 |
| Average | 50.17 | −8.03 | −7.56 | Average | 38.73 | 17.87 | 2.00 |
| STD | 0.11 | 0.75 | 2.01 | STD | 0.80 | 2.19 | 1.10 |
| T = 4 hours | L | A | B | T = 4 hours | L | A | B |
| Control | 50.92 | −4.2 | −13.81 | Samplea 1 (Sika ® | 49.4 | −16.34 | −16.51 |
| (Sika ® | 50.52 | −7.65 | −9.01 | Antisol ® + the | 46.53 | −10.03 | −14.23 |
| Antisol ®) | 50.67 | −6.42 | −11.57 | present additive) | 46.3 | −9.4 | −13.86 |
| Average | 50.70 | −6.09 | −11.46 | Average | 47.41 | −11.92 | −14.87 |
| STD | 0.20 | 1.75 | 2.40 | STD | 1.73 | 3.84 | 1.44 |
| T = 24 hours | L | A | B | T = 24 hours | L | A | B |
| Control | 50.85 | −3.59 | −11.34 | sample 1 (Sika ® | 49.47 | −13.13 | 17.11 |
| (Sika ® | 50.98 | −2.65 | −13.34 | Antisol ® + the | 49.43 | −15.21 | 19.05 |
| Antisol ®) | 50.93 | −3.06 | −12.4 | present additive) | 49.43 | −14.83 | 19.07 |
| Average | 50.92 | −3.10 | −12.36 | Average | 49.44 | −14.39 | 18.41 |
| STD | 0.07 | 0.47 | 1.00 | STD | 0.02 | 1.11 | 1.13 |

From the experimental data it is possible to conclude that L, a and b describe the AM color degradation in cement. Values obtained show that cement with Sika® Antisol® and the present additive (L=37) has an initial luminosity of 13 points lower compared to cement with Sika® Antisol® (L=50), however, is able to achieve luminosities similar to cement with Sika® Antisol® due to its photocatalytic capacity. Specifically, its final luminosity is 49, with an average delta L of 11 vs cement with Sika® Antisol® has an average variation of only 0.7 (no degradation occurs). Thus, the best blue degradation to methylene blue is evidenced to cement which is treated with Sika® Antisol® and the present additive (Photio), showing a doping of Sika® Antisol® with the present additive to cement which confers a photocatalytic activity under UV radiation.

### Methylene Blue Degradation Tests, UV-VIS

Methylene blue degradation was analyzed on the surface of Anistol samples which were deposited on plastic Petri plates and the same is also suspended in a colorant solution. After submitted to radiation a colorant solution loses color and becomes transparent along to the exposure time. This degradation reaction is catalyzed in presence of the photocatalyst, which accelerates the degradation after radiation exposure. To ways are used, one under film format and other in suspension. Film format generates a uniform film as matrix sample to be evaluated on which 20 mL of methylene blue solution (0.02 mM) was added to adjust pH. After the solution starts to decolor due to the adsorption/absorption of colorant in antisol, which causes a regeneration of the solution up to a change of color stops after 1 hour and absorbance cannot vary beyond 10%. Once achieved an equilibrium the photodegradation starts and samples are irradiated, and absorbance measured along time.

Alternatively, an antisol film (1 gr) of particles having an homogeneous size is added in 25 mL of methylene blue solution (0.02 mM) and conditioned in darkness under agitation of 350 rpm. Similarly, the same phenomena observed to a static film occurred then the solution was regenerated app. each 2 hours up to the discoloring stops and consequently particles are filtered, and the decolored solution discarded.

Antisol samples were prepared as mentioned before and then carried out to an assay format. Firstly, 10 grams of the present additive+Sika® Antisol® are applied but agitating the content of the containers before applying and depositing on plastic Petri plates of 90 mm. After applied plates are softly agitated up to obtain a homogeneous film. 10 grams of Sika® Antisol® are added in a different plate as described immediately above. Samples are dried for at least 12 hours. 20 ml of methylene blue solution (0.02 mM) are added to the samples prepared as described above, after samples are kept in darkness for 30 minutes, if the solution is discolored the solution is changed, otherwise samples are checked after 2 hours. If discoloring does not notoriously vary the change of absorbance is evaluated by UV-Visible in 30 minutes with fresh solution. If absorbance does not vary over 10% the sample is ready to evaluate the photodegradation. Samples are introduced into UVC-light degradation chambers. Distance between samples and lamps is 20 cm] and absorbance is evaluated at 30 minutes, 1 hour, 2 hours and 3 hours. Graphs (A/Ao)*100 are generated to observe the normalized change of the initial absorbance vs time of radiation, contrasting responses between control and samples having the present additive.

For samples of suspension, firstly 1 g of sample is detached from a film having the present additive+Sika® Antisol®, using a clean spatula, seeking the comminution of the sample to flakes or the like. Sample is located in a vessel of 100 mL. Separately, other vessel of 100 ml receives 1 g of Sika® Antisol® coming from a dried film according to the described immediately above. 25 ml methylene blue solution (0.02 mM) is added to the plates having the prepared samples and then the same are submitted to 30 min of darkness with agitation 350 rpm, if a decoloring has occurred the solution is changed otherwise plates are checked after 2 hours. If the solution is changed, the same is filtered with conventional paper filter discarding the decolored solution and recovering the solid material remaining in the filter paper. If variation of color to the solution is not notorious the change of absorbance is evaluated by UV-visible spectroscopy in 30 minutes with fresh solution. If the absorbance does not vary beyond 10% the sample is ready to evaluate photodegradation. To evaluate this cloudy samples, 2 ml of solution are taken and centrifugated at 1400 rpm for 5 minutes and then aliquots (200 μL) are taken to spectroscopy. UVA light is on without stopping the agitation. Distance between samples and lamps is 20 cm to evaluate the absorbance at 1 hour and 2 hours points are added depending on the decoloring of the sample. Graphs (A/Ao)*100 are generated to observe the normalized change of initial absorbance vs time of radiation, contrasting responses between control and the present additive.

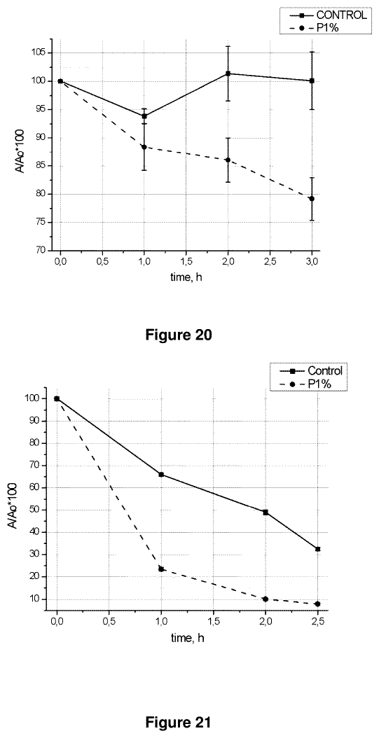

Table 17 and FIG. 20 show the results of the (A/Ao)*100 variations to control (Sika® Antisol®) and the mixture (Sika® Antisol®+Photio (1%)), after 0, 1, 2 and 3 hours. Table 18 shows the related measurements.

TABLE 17
AM degradation results in film with Sika ® Antisol ®
and Sika ® Antisol ® + the present additive

| | (A/Ao)*100 | | | |
|---|---|---|---|---|
| Samples | 0 hours | 1 hour | 2 hours | 3 hours |
| Control (Sika ® Antisol ®) | 100 ± 0 | 94 ± 1 | 101 ± 5 | 100 ± 5 |
| Sample 1% (Sika ® | 100 ± 0 | 88 ± 4 | 86 ± 4 | 79 ± 4 |
| Antisol ® + Photio) | | | | |

TABLE 18

| | |
|---|---|
| Control | P1 % |

| t (h) | Average | DS | Average | DS |
|---|---|---|---|---|
| 0 | 100 | 0 | 100 | 0 |
| 1 | 94 | 1 | 88 | 4 |
| 2 | 101 | 5 | 86 | 4 |
| 3 | 100 | 5 | 79 | 4 |

Table 19 and FIG. 21 show (A/Ao)*100 variation results to control control (Sika® Antisol®) and 1% mixture (Sika® Antisol®+the present additive, P1%) after 0, 1, 2 and 2.5 hours. Table 20 shows the related measurements.

TABLE 19
AM degradation results in Sika ® Antisol ® and Sika ®
Antisol ® + the present additive suspensions

| | (A/Ao)*100 | | | |
|---|---|---|---|---|
| Samples | 0 hours | 1 hour | 2 hours | 2.5 hours |
| Control | 100 ± 0 | 95.9 ± 0.4 | 48.9 ± 1 | 32.4 ± 0.7 |
| (Sika ® Antisol ®) | | | | |
| Sample 1 | 100 ± 0 | 23.4 ± 0.8 | 9.9 ± 0.6 | 7.8 ± 0.5 |
| (Sika ® Antisol ® + the | | | | |
| present additive) | | | | |

TABLE 20

| | |
|---|---|
| Control | P1 % |

| t (h) | Average | DS | Average | DS |
|---|---|---|---|---|
| 0 | 100.0 | 0.0 | 100.0 | 0.0 |
| 1 | 66.0 | 0.4 | 23.4 | 0.8 |
| 2 | 48.9 | 1.0 | 10.0 | 0.6 |
| 2.5 | 32.4 | 0.7 | 7.8 | 0.5 |

TABLE 21
AM Degradation results in Sika ® Antisol ® and
Sika ® Antisol ® + the present additive
in suspension, at different concentrations

| T | Control | | 0.10% | | 0.50% | | 1% | |
|---|---|---|---|---|---|---|---|---|
| (min) | Average | DS | Average | DS | Average | DS | Average | DS |
| 0 | 100 | 0 | 100 | 0 | 100.0 | 0.0 | 100 | 0 |
| 60 | 88 | 3 | 87 | 1 | 32.9 | 0.7 | 92 | 1 |
| 120 | 76 | 2 | 73 | 2 | 10.3 | 0.7 | 75 | 1 |
| 180 | 66 | 2 | 60 | 2 | 7.6 | 0.6 | 58 | 1 |

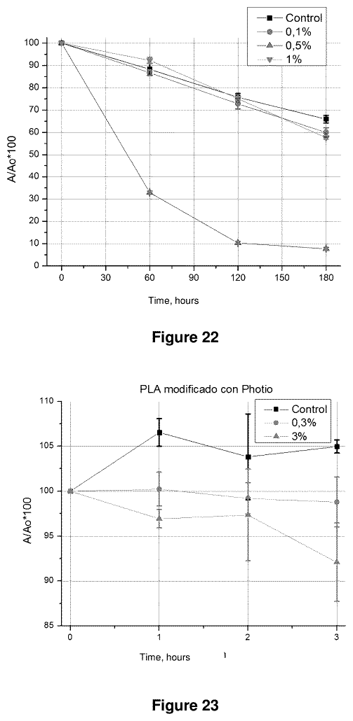

FIG. 22 show the results obtained to modifying the present additive concentration in the matrix (Antisol®). The best result is obtained with the present additive at 0.5% while to the mixture prepared at 1% non-results as the ones previously observed, are achieved. It should be noted that combinations remain a greater time in conditioning since there was an evident decoloring in absence of UV radiation then the matrix absorbs big amounts of colorant. Mixtures were made according to the mentioned before but only adjusting the present additive dispersion mass to be incorporated.

Thus, the absorbance variation is a way to quantify the colorant concentration and application of radiation in presence or absence of catalyst generates its degradation. From the values obtained is noted that Sika® Antisol® and the present additive show a lower (A/Ao)*100 than Sika® Antisol® then a low colorant concentration with a greater irradiation time, additionally, in suspension, degradation is greater but taking lower time although a UVA lamp is used, which has lower energy compared to a UVC lamp. Addition of the present additive (1%) in Sika® Antisol® matrix a photocatalytic material disposed as film is obtained, which can be able to degrade methylene blue in solution reducing its absorbance from 100% to 79±4% in 3 hours of UVC light radiation while Sika® Antisol® without the present additive does not show reduction in absorbance. But in suspension, when the present additive is added a reduction of the normalized absorbance from 100% to 7.8±0.5% is observed in 2.5 hours of UVA radiation while to control the reduction is from 100% to 32.4 ±0.7%, i.e., 4-folds greater. In suspension measurements show a very low deviation in the calculated average value, not over 1%. However, to a film error is at least 1% but generally bear to 4 and 5%, which could be caused by the absence of agitation and the solution was not homogenized and show zones having a greater concentration.

To compare the amount of the present additive in the matrix, no major linearity is observed and the most remarkable behaivor is associated to mixture 0.5%. Finally, the major degradation of methylene blue is associated to Sika® Antisol® having the present additive, demonstrating that the doping of Sika® Antisol® with the present additive confers photocatalytic activity under UVA radiation. A greater degradation is achieved when 0.5% of the present additive is added under UVA light and constant agitation.

### Example 8: Hydrophobic and Catalytic Properties of Fabrics Modified with The Present Additive

Present additive corresponding to a nanoparticle mixture in water together with polycarboxylate ether-based dispersant and any other dispersant to optimally associate with the final product are applied in a portion (10×10 cm) of a fabric 100% natural cotton, having 144 g/m² thickness. Fabric is submerged in a suspension having the present additive (20%) and agitated for a while to then be styled and dried at room temperature. Control is fabric with the present additive.

Firstly, water suspensions (300 g pure water) of the present additive (0.3% and 3%) were prepared from 4.56 g and 52.94 g of the present additive (20%), respectively. Suspensions were agitated for 10 minutes, and then, the fabric submerged and submitted to 15 minutes of a further agitation. After ended, the fabric is styled and dried for 6 hours at room temperature, and then washed with water and ethanol, and subsequently dried for 6 hours at room temperature. Thus, after prepared and dried the sample is split on 4 pieces. Control is fabric free of the present additive. Sample 1 is fabric submerged in the present additive (0.3%). Sample 2 is fabric submerged in the present additive (3%).

Hydrophobicity is measured from tests consisting in evaluating the capability of separation of oil/water mixtures. Fabric is firstly fixed to a filter. Then, oil/water mixtures are dumped on the fabric to achieve the oil/water separation. Separation efficacy to several oil/water mixtures are calculated from de ratio m to m0 multiplied by 100%, wherein m0 and m are water mass before and after the separation, respectively.

Photocatalytic activity is measured by colorimeter technique. A stock sample of methylene blue (5 mM) is prepared, which is prepared from diluted Solutions (0.02 mM), which in turn are prepared from water type I. Rhodamine B colorant is used to evaluate from the stock sample (5 mM). The AM and Rhodamine B degradation was evaluated from the surfaces of fabrics. Degradation is evaluated as a change of color vs time. PCR XXM30 colorimeter was used to measure color. PCE XXm30 is used to measure color since such equipment can determine the following spaces of color: CIE-LAB, CIE-LCh, HunterLab, CIE-Luv, XYZ, RGB. A LED having a length wave between 400-700 nm is used as integrated light source. Colorimeter has a aperture of 8 mm (diameter, Ø) and this equipment works with a repeatability of ΔE*ab≤0.1. From the available color spaces CIE-LAB is chosen since it is the most used in photocatalytic studies as mentioned above. The 3 samples are submitted to colorimetric test. Firstly, samples are dyed with methylene blue and rhodamine B, and after dried to measure parameters L, a and b using the colorimeter. Samples are added into the UVC light chambers. Distance between samples and lamps is 8 cm, and colors are measured at 0, 2 and 3 hours.

Performed dynamic assays it was evaluated the time involved in that 10 g water pass through a modified cotton membrane. Table 22 shows the hydrophobicity results in a modified fabric having the present additive.

TABLE 22

| Sample | Time [s] |
|---|---|
| Control: Tela 0% the present additive | 6 |
| Sample 1: fabric having the present additive (0.3%) | 9 |
| Sample 2: fabric having the present additive (3%) | 25 |

Thus, the resistance of the membrane to water passing through is confirmed which is related to the hydrophobicity of the material.

Table 23 show the variation results to parameters L, a and b to methylene blue colorant after 1, 2 and 3 hours.

TABLE 23
Varitions dL, da and db to methylene blue vs time

| | Control | 0.3% present additive | 3% present additive |
|---|---|---|---|
| dL Blue | | | |
| 1 hour | 1.59 | 6.88 | 2.93 |
| 2 hours | 1.93 | 6.39 | 5.34 |
| 3 hours | 2.39 | 9.29 | 6.43 |
| da Blue | | | |
| 1 hour | 2.51 | 25.84 | 3.31 |
| 2 hours | 3.51 | 25.88 | 32.45 |
| 3 hours | 1.36 | 27.53 | −14.20 |
| db Blue | | | |
| 1 hour | 0.55 | 2.95 | 5.82 |
| 2 hours | 2.24 | 5.42 | 7.75 |
| 3 hours | 3.50 | 9.79 | 10.76 |

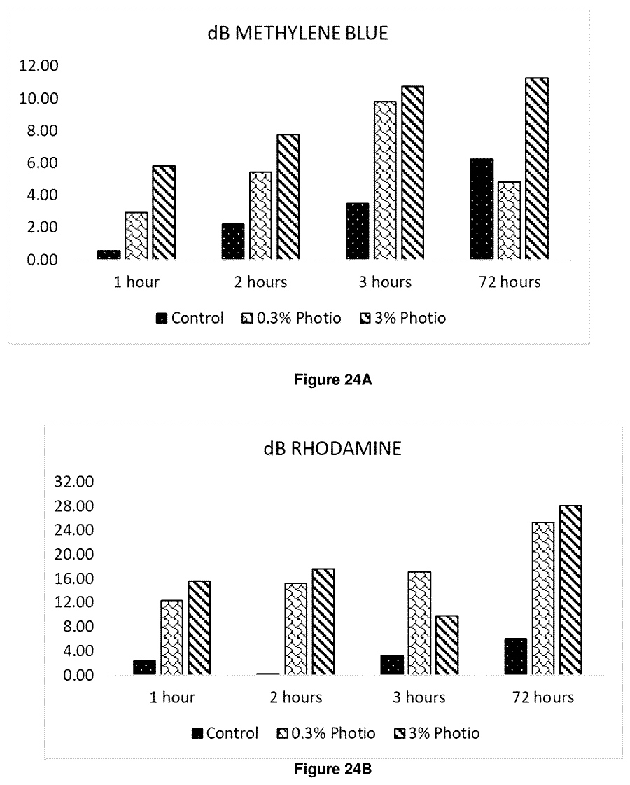

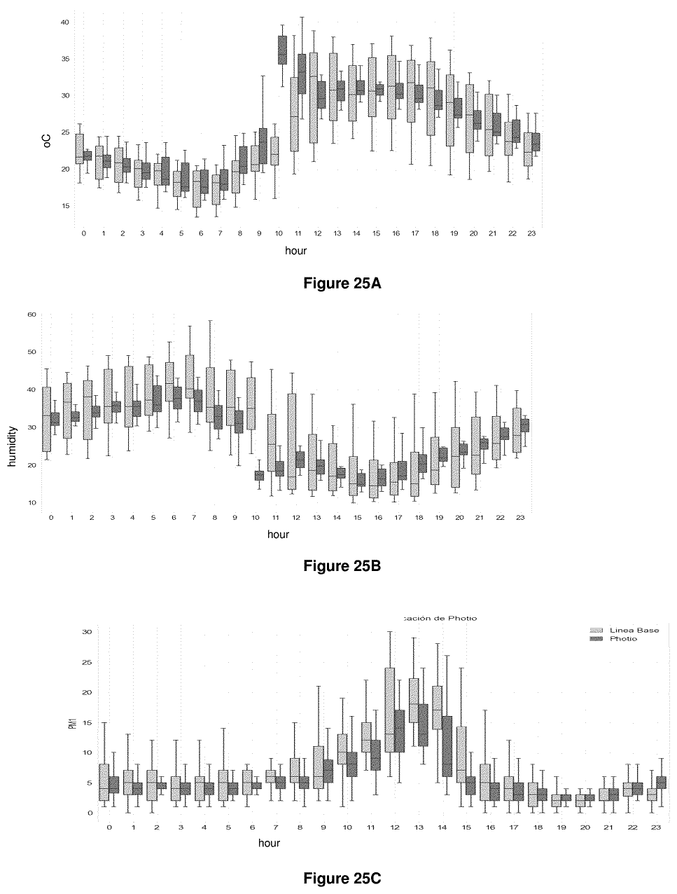

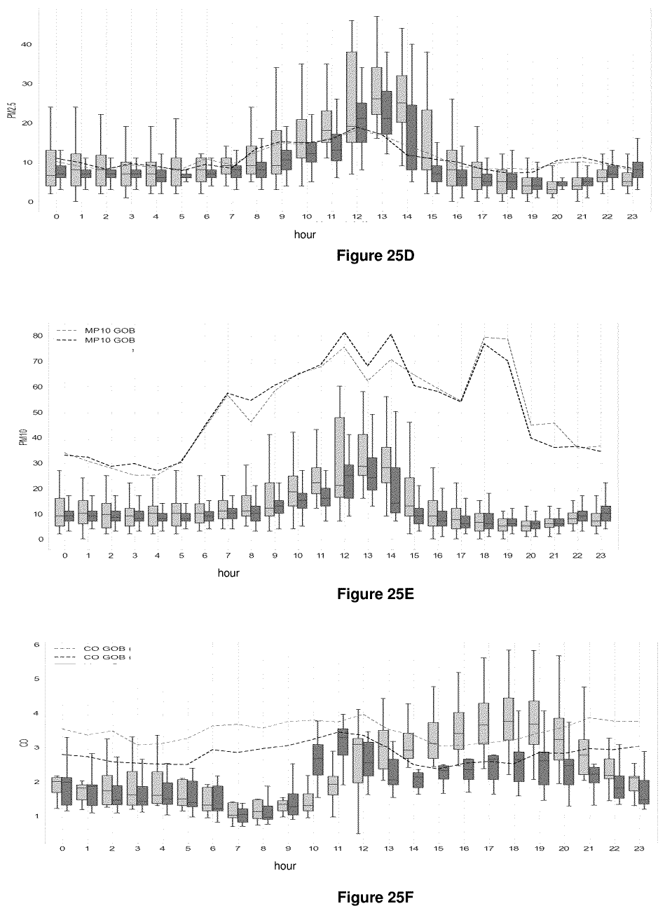

Axis b is the parameter that better reflects the colorant degradation, representing to yellow and blue components as +b (positive) and −b (negative) values, respectively. Further, the effect of the present additive into the fabric were effectively quantified. See FIG. 24A. Table 24 shows these measurements.

Table 24 shows variation results to parameters L, a and b to Rhodamine B, after 1, 2 and 3 hours.

TABLE 24

| | Control | 0.3% present additive | 3% present additive |
|---|---|---|---|
| dL Rhodamine B | | | |
| 1 hour | 0.29 | 6.65 | 9.69 |
| 2 hours | 0.50 | 8.47 | 11.63 |
| 3 hours | 0.36 | 10.43 | 6.82 |
| da Rhodamine B | | | |
| 1 hour | 34.03 | 1.80 | 88.13 |
| 2 hours | 32.40 | 4.40 | 92.46 |
| 3 hours | 31.80 | 4.60 | 75.27 |
| db Rhodamine B | | | |
| 1 hour | 2.38 | 12.39 | 15.66 |
| 2 hours | 0.29 | 15.26 | 17.65 |
| 3 hours | 3.30 | 17.15 | 9.82 |

Similarly to AM, axis b is the parameter that better reflects the degradation of Rhodamine B colorant, representing yellow and blue colors as +b (positive) and −b (negative) values, respectively. Further, the effect of the present additive into the fabric were effectively quantified. See FIG. 24B. Table 25 shows these measurements.

From AM evaluation it is noted that there is a degradation caused by UV light since there is a variation in control after 3 hours of radiation (dB=3.50), which is potentiated with the present additive (arbitrarily, named Photio), and then the photocatalytic activity was demonstrated (dB=10.76 to sample 2 containing 3% the present additive). Also a direct relationship between the concentration of the present additive and colorant degradation was confirmed. Sample having 0.3% the present additive achieves dB 9.79 and sample having 3% the present additive achieves a dB 10.76.

To Rhodamine B colorant, sample 2 having 3% the present additive achieves up to dB 17.65 after 2 hours while control achieves only dB 3.30 after 3 hours. Thus, the present additive shows a better efficiency with colorant Rhodamine B compared to AM. However, after 3 hours the degradation of the sample having 3% the present additive does not increases as after 2 hours. As opposed, sample 1 (0.3% the present additive) achieves degradation value (dB=17.15) near to the ones exhibited by sample 2 (3% the present additive). These results validate the photocatalytic activity of the present additive in fabrics, which are able to degrade almost 70% more than control to AM and more than 80% to Rhodamine B.

### Example 9: Performance Under Real Conditions

To evaluate the present additive under real conditions, the present additive was added to a wall of 40 m² corresponding to a nanoparticle mixture in water together with polycarboxylate ether-based dispersant and any other dispersant to optimally associate with the final product. The present additive (0.3% and 0.6%) was directly added into waterborne enamel paint pots. To evaluate the efficacy of the present additive it was used an equipment able to measure relative humidity, temperature, UV radiation and CH₄, CO, NO, NO₂ and particulates (PM1, PM2.5 and PM10) concentrations.

Firstly, the evaluation comprises 2 steps: A first step (arbitrarily named “baseline”) where measurements free of additive were made for at least 1 week to understand gases behavior and meteorological variables as free of the effect of the present additive. After cured the paint, step 2 starts to quantify the effect of the present additive. Sensors were connected to the electrical network. Two monitoring gas stations perform measurements and records each 2 minutes, and this was used to calibrate measurements, which allows a local register of the above-mentioned parameters/variables. Measurements were made for 5 days to baseline and the present additive, respectively. CO, PM2.5 and PM10 parameters was compared to the official data from the air quality national system.

Temperature and humidity results show the expected theorical trends, i.e., an increase of the relative humidity to night-early morning and a decrease of the relative humidity at morning-afternoon while temperature shows an opposed behavior compared to humidity. If compared baseline data set with the application of the present additive maintain the wall in 2° C. over the environmental temperature during the day, while relative humidity decreases 3% after applied the present additive. To particulates the behavior is similar therebetween, along the day, and to the data of the air quality national system, increasing during morning-afternoon and decreasing during night-early morning. The present additive reduces the particulate concentration to the 3 types of particulate material. During afternoon, where there is a greater radiation, PM1, PM2.5 and PM10 variables show an average reduction of app. 26%. To 24 hours, an average reduction was 21% PM1, 20% PM2.5 and 19% PM10. The CO concentrations are between 0.5 and 5.8 ppm in baseline and 0.7 and 4.1 ppm to the present additive. Data from sensors is similar to data of the air quality national system. CO results are 30% lower as average during afternoon (when there are a highest radiation) when the present additive is applied but such average reduction is 13% after 24 hours. Similarly, CH₄ concentration reduces 90% during afternoon, although there is a high variability data. To morning-afternoon (10:00-17:00) a greater gas concentration is showed.

NO Baseline concentration is between 0.6 and 23.81 ppm but after applied the present additive such range is between 0.6 and 22.15 ppm. Remotion efficacy is 2% at morning (6:00-12:00), 1.2% at afternoon (12:00-19:00), 0.32% at night (19:00-24:00) and 0.4% early morning (0:00-6:00).

Sensors of the gas monitoring stations as used show results within the magnitude and behavior reported by the air quality national system to CO and particulate. Temperature and humidity sensors show results as the ones theoretically expected. The efficacy of the present additive to reduce CO, a contaminant gas, was demonstrated. 13% as average by day. Similarly, the efficiency of the present additive to remove particulate (PM1, PM2.5 and PM 10) was demonstrated since significant amounts of remotion were detected, the best remotion was a reduction over 25% by afternoon. To NO, the efficiency of remotion to the present additive is 2% at morning, 1.2% at afternoon, 0.32% at night and 0.4% at early morning. Data is summarized in table 25 below.

TABLE 25

| | | Early morning | | | Morning | | | Afternoon | | | Night | | |
|---|---|---|---|---|---|---|---|---|---|---|---|---|---|
| | | | Present | Delta, | | Present | Delta, | | Present | Delta, | | Present | Delta, |
| | | Baseline | additive | % | baseline | additive | % | Baseline | additive | % | baseline | additive | % |
| Room | Count | 479.00 | 600.00 | 25.26 | 850.00 | 899.00 | 5.76 | 840.00 | 1036.00 | 23.33 | 1050.00 | 1050.00 | 0.00 |
| temperature | Mean | 24.71 | 25.37 | 2.65 | 22.41 | 27.08 | 20.87 | 30.07 | 30.22 | 0.51 | 19.63 | 19.99 | 1.84 |
| | Std | 4.26 | 2.14 | −49.81 | 5.69 | 6.96 | 22.21 | 5.15 | 1.96 | −61.99 | 2.70 | 2.15 | −20.20 |
| | Min | 18.17 | 21.63 | 19.06 | 13.47 | 15.83 | 17.57 | 19.14 | 25.54 | 33.47 | 13.43 | 15.70 | 16.96 |
| | 25% | 20.95 | 23.77 | 13.47 | 18.76 | 20.31 | 8.24 | 26.03 | 28.89 | 10.99 | 17.89 | 18.23 | 1.87 |
| | 50% | 23.79 | 24.93 | 4.83 | 21.18 | 27.77 | 31.13 | 30.64 | 30.15 | −1.63 | 19.81 | 20.14 | 1.68 |
| | 75% | 28.26 | 26.79 | −5.21 | 24.56 | 32.81 | 33.57 | 34.73 | 31.38 | −9.67 | 21.38 | 21.53 | 0.71 |
| | Max | 33.07 | 30.42 | −8.02 | 38.78 | 40.61 | 4.72 | 38.06 | 34.59 | −9.11 | 26.04 | 25.03 | −3.89 |
| Humidity | Count | 479.00 | 600.0 | 25.26 | 850.00 | 899.00 | 5.76 | 840.00 | 1036.00 | 23.33 | 1050.00 | 1050.00 | 0.00 |
| | Mean | 26.49 | 28.19 | 6.42 | 34.35 | 26.26 | −23.53 | 19.30 | 19.86 | 2.91 | 36.58 | 34.84 | −4.74 |
| | Std | 8.58 | 5.47 | −36.24 | 10.97 | 8.22 | −25.04 | 8.40 | 4.89 | −41.75 | 8.51 | 3.32 | −61.01 |
| | Min | 12.56 | 19.03 | 51.24 | 11.74 | 13.17 | 12.16 | 9.87 | 12.81 | 29.72 | 21.27 | 27.89 | 31.14 |
| | 25% | 20.33 | 24.22 | 19.13 | 26.74 | 18.73 | −29.98 | 12.38 | 16.31 | 31.76 | 29.28 | 32.31 | 10.34 |
| | 50% | 24.76 | 27.03 | 9.15 | 34.34 | 24.03 | −30.02 | 16.29 | 18.42 | 13.07 | 37.41 | 34.53 | −7.69 |
| | 75% | 34.84 | 31.11 | −10.71 | 43.62 | 33.46 | −23.32 | 25.75 | 22.25 | −13.57 | 44.02 | 36.63 | −16.79 |
| | Max | 42.08 | 40.69 | −3.30 | 56.23 | 43.18 | −25.85 | 39.08 | 32.98 | −15.61 | 52.61 | 43.59 | −17.15 |
| CO | Count | 479.00 | 600.00 | 25.26 | 850.00 | 899.00 | 5.76 | 840.00 | 10.36 | 23.00 | 1050.00 | 1050.00 | 0 |
| | Mean | 2.65 | 2.12 | −19.89 | 1.65 | 1.99 | 20.57 | 3.50 | 2.45 | −29.91 | 1.90 | 1.68 | −11.67 |
| | Std | 0.99 | 0.75 | −24.34 | 0.74 | 0.94 | 27.46 | 1.02 | 0.72 | −29.67 | 0.73 | 0.56 | −23.34 |
| | Min | 1.30 | 1.20 | −8.14 | 0.48 | 0.70 | 44.78 | 2.03 | 0.65 | −68.02 | 0.94 | 0.81 | −13.87 |
| | 50% | 2.32 | 1.99 | −14.19 | 1.37 | 1.88 | 36.63 | 3.31 | 2.28 | −30.98 | 1.67 | 1.45 | −12.89 |
| | Max | 5.66 | 3.91 | −30.81 | 4.10 | 3.97 | −3.30 | 5.83 | 4.06 | −30.29 | 3.51 | 3.41 | −3.03 |
| CH₄ | Count | 412.00 | 254.00 | −38.35 | 379.00 | 562.00 | 48.28 | 742.00 | 437.00 | −41.11 | 6.06 | 47.5 | −21.62 |
| | Mean | 0.00 | 0.00 | −90.94 | 0.00 | 0.00 | 160.08 | 0.00 | 0.00 | −88.55 | 0.00 | 0.00 | 99.71 |
| | Std | 0.00 | 0.00 | −96.68 | 0.00 | 0.00 | 292.55 | 0.00 | 0.00 | −78.82 | 0.00 | 0.00 | 70.35 |
| | Min | 0.00 | 0.00 | 0.00 | 0.00 | 0.00 | 0.00 | 0.00 | 0.00 | 0.00 | 0.00 | 0.00 | 0.00 |
| | 50% | 0.00 | 0.00 | 72.29 | 0.00 | 0.00 | 41.13 | 0.00 | 0.00 | −95.68 | 0.00 | 0.00 | −60.84 |
| | Max | 0.00 | 0.00 | −97.27 | 0.00 | 0.00 | 323.52 | 0.00 | 0.00 | −62.01 | 0.00 | 0.00 | 115.49 |
| NO | Count | 479.00 | 600.00 | 25.26 | 850.00 | 899.00 | 5.76 | 840.00 | 1036.00 | 23.33 | 1050.00 | 1050.00 | 0.00 |
| | Mean | 15.15 | 15.42 | 1.78 | 14.79 | 14.97 | 1.18 | 15.11 | 15.16 | 0.32 | 15.07 | 15.12 | 0.35 |
| | Std | 3.14 | 2.81 | −10.58 | 4.12 | 3.04 | −26.22 | 1.80 | 1.55 | −13.82 | 2.32 | 1.73 | −25.14 |
| | Min | 0.60 | 0.60 | 0.00 | 0.39 | 0.59 | 0.00 | 2.57 | 4.98 | 94.04 | 3.36 | 2.46 | −26.85 |
| | 50% | 15.64 | 15.72 | 0.48 | 15.67 | 15.57 | −0.59 | 15.32 | 15.29 | −0.65 | 15.37 | 15.26 | −0.74 |
| | Max | 23.81 | 22.16 | −6.93 | 23.62 | 20.73 | −12.20 | 23.11 | 20.06 | −13.16 | 21.23 | 20.64 | −2.79 |
| PM1 | Count | 479.00 | 600.00 | 25.26 | 850.00 | 899.00 | 5.76 | 840.00 | 10.38 | 23.33 | 1050.00 | 1050.00 | 0.00 |
| | Mean | 3.05 | 3.84 | 25.76 | 10.75 | 8.04 | −25.21 | 8.71 | 6.43 | −26.19 | 5.49 | 4.40 | −19.74 |
| | Std | 1.86 | 2.26 | 21.38 | 6.51 | 4.07 | −37.47 | 7.68 | 5.58 | −27.25 | 3.87 | 1.84 | −52.44 |
| | Min | 0.00 | 0.00 | — | 1.00 | 1.00 | 0.00 | 0.00 | 0.00 | | 0.00 | 1.00 | |
| | 50% | 3.00 | 3.00 | 0.00 | 9.00 | 7.00 | −22.22 | 6.00 | 4.00 | −33.33 | 0.00 | 4.00 | −20.00 |
| | Max | 9.00 | 20.00 | 122.22 | 30.00 | 22.00 | −26.67 | 29.00 | 26.00 | −10.34 | 19.00 | 29.00 | 52.63 |
| PM2.5 | Count | 479.00 | 600.00 | 25.26 | 850.00 | 899.00 | 5.76 | 840.00 | 1036.00 | 23.33 | 1050.00 | 1050.00 | 0.00 |
| | Mean | 5.33 | 6.61 | 23.86 | 16.76 | 12.45 | −25.70 | 13.39 | 10.22 | −24.74 | 9.04 | 7.32 | −18.96 |
| | Std | 2.71 | 3.38 | 24.81 | 10.41 | 6.13 | −41.08 | 11.74 | 8.52 | −27.40 | 6.13 | 2.84 | −53.72 |
| | Min | 0.00 | 1.00 | — | 3.00 | 3.00 | 0.00 | 0.00 | 1.00 | | 0.00 | 2.00 | |
| | 50% | 5.00 | 6.00 | 20.00 | 14.00 | 11.00 | −21.43 | 9.00 | 7.00 | −22.22 | 8.00 | 7.00 | −12.50 |
| | Max | 15.00 | 33.00 | 120.00 | 46.00 | 34.00 | −26.09 | 47.00 | 40.00 | −14.89 | 3.00 | 37.00 | 23.33 |
| PM10 | Count | 479.00 | 600.00 | 25.26 | 850.00 | 899.00 | 5.76 | 840.00 | 1036.00 | 23.33 | 1050.00 | 1050.00 | 0.00 |
| | Mean | 7.01 | 8.26 | 17.71 | 20.00 | 14.82 | −25.90 | 15.86 | 12.31 | −22.39 | 10.78 | 9.28 | −13.89 |
| | Std | 3.34 | 4.15 | 24.17 | 12.52 | 6.91 | −44.78 | 13.66 | 9.82 | −28.11 | 6.72 | 3.84 | −42.86 |
| | Min | 1.00 | 1.00 | 0.00 | 3.00 | 3.00 | 0.00 | 0.00 | 1.03 | | 0.00 | 3.00 | |
| | 50% | 6.00 | 7.00 | 16.67 | 16.00 | 13.00 | −18.75 | 11.00 | 9.00 | −15.18 | 10.00 | 8.00 | −20.00 |
| | Max | 20.00 | 42.00 | 110.00 | 60.00 | 41.00 | −31.67 | 58.00 | 50.00 | −13.79 | 35.00 | 46.00 | 31.43 |

### Example 10: Microbiological assays

Previously isolated bacteria were incubated in a LB medium (Luria-Bertani (LB) medium, oftenly used to E. coli culturing, among other bacteria. Mainly based on 3 components: NaCl as mineral and triptone/peptone and yeast extract as organic source) under constant agitation and at 35° C., up to achieve the exponential phase (Marr AG. Growth rate of Escherichia coli. Microbiol Rev. 1991). Then, bacteria were centrifugated and washed with sterile water, 3-times. This medium having the present additive were inoculated with 100uL bacteria as previously prepared, at different concentrations (5%, 3%, 1% and 0.3%), under agitation (120 rpm) at 35° C. for 24 hours. Aliquots of 100 uL of samples of LB medium at different concentration of the present invention were taken and serially diluted up to 10-8 autoclaved sterile water and spread on LB agar plates. A colony counting was made after 72 hours after incubated at 35° C. Table 26 shows the results of this microbiological tests.

TABLE 26

| | Present additive | | | | | | | |
|---|---|---|---|---|---|---|---|---|
| Microorganism | N, UFC/ml | 5% | 3% | 1% | 0.3% | n1, 10% | n2, 10% | n3, 10% |
| E. coli | 68 × 10⁸ | 0 | 1 × 10⁴ | <1 × 10⁴ | 2.2 × 10⁸ | <1 | 2 | 1 |
| S. aureus | 68 × 10⁸ | 0 | 3 × 10⁴ | 42 × 10⁴ | 25 × 10⁸ | | | |

### Example 11: Nanoparticles Evaluation to Determine Plasmon and Calculating Bandgap

To examples 11 and 12, the following nanoparticles codes are used: TiO₂ (T), ZnO (Z), Al₂O₃ (A), CuO (CO) and Cu (C).

Nanoparticles T, Z, A, O and C plus Tween 80 and ultra-pure water (alternatively, distilled water or ethanol) were mixed. 0.25 g Tween 80 were dissolved in 250 ml water and 5 vessels were prepared adding each vessel 0.25 g of each nanoparticle. Vessel 1-T, vessel 2-Z, vessel 3-A, vessel 4-CO, vessel 5-C. 1 mg/ml of each mixture is taken to prepare dispersions, agitating at 500 rpm for 5 min. Subsequently, dispersions are settled and 200 μL from the upper part of the suspension (free of settled material) is taken and dissolved in 9 mL distilled water (sample arbitrarily named DX (wherein X related to the number of vessel, i.e., 1, 2, 3, 4 or 5). After 1 mL of each dispersion is taken and dissolved in distilled water (sample arbitrarily named DdX (wherein X related to the number of vessel, i.e., 1, 2, 3, 4 or 5). Subsequently, a well to UV measurements is prepared as shows table 27:

TABLE 27

| Row/ | | | | | | | | | | | | |
|---|---|---|---|---|---|---|---|---|---|---|---|---|
| Column | 1 | 2 | 3 | 4 | 5 | 6 | 7 | 8 | 9 | 10 | 11 | 12 |
| A | control | control | control | Vessel 1 | Vessel 1 | Vessel 1 | D1 | D1 | D1 | Dd1 | Dd1 | Dd1 |
| B | control | control | control | Vessel 2 | Vessel 2 | Vessel 2 | D2 | D2 | D2 | Dd2 | Dd2 | Dd2 |
| C | control | control | control | Vessel 3 | Vessel 3 | Vessel 3 | D3 | D3 | D3 | Dd3 | Dd3 | Dd3 |
| D | control | control | control | Vessel 4 | Vessel 4 | Vessel 4 | D4 | D4 | D4 | Dd4 | Dd4 | Dd4 |
| E | control | control | control | Vessel 4 | Vessel 4 | Vessel 4 | D5 | D5 | D5 | Dd5 | Dd5 | Dd5 |

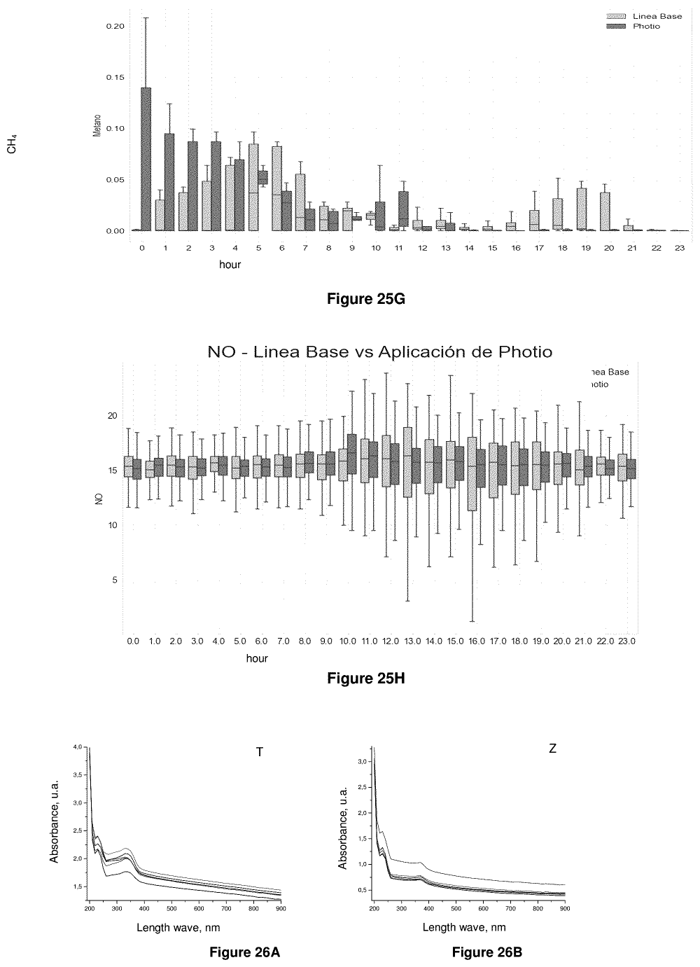

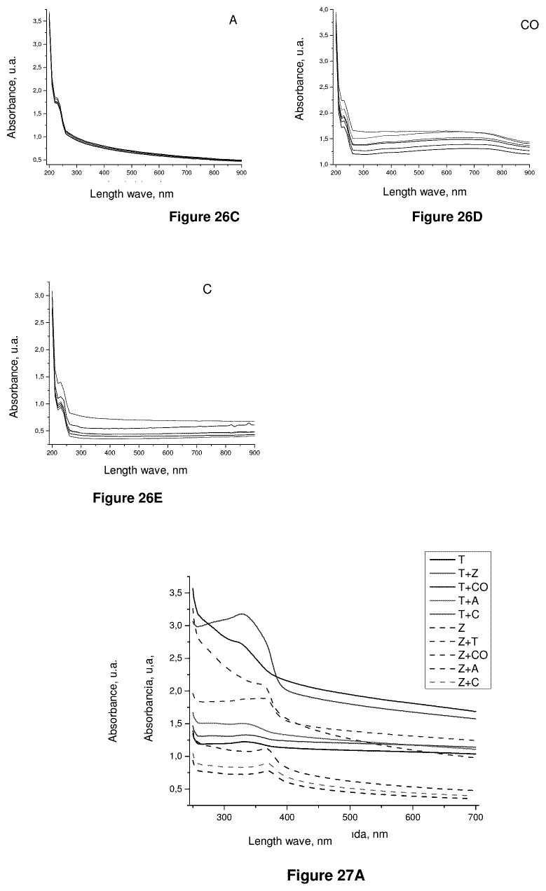

A second iteration was evaluated, each sample was submitted to 10 min of agitation at 1000 rpm. After applied an extended agitation and a greater intensity, dispersion is maintained stable for a greater time, allowing the measurement of each particle per se. Bandgap is calculated from a hv (calculated photon energy as: 1240/length wave) vs (ahv)² graph, wherein a corresponds to absorption coefficient. From this graph, a bandgap is obtained as the X-axis intersection. FIGS. 26A-26E show graphs per each nanoparticle. It should be noted that T and Z are known as photoactive molecules (FIG. 26A and FIG. 26B). A (FIG. 26C) shows a signal increasing but the container used absorbs energy (polystyrene, 230 nm). CO (FIG. 23D) also shows an absorbance increasing between 400 and 700 nm, suggesting a potential photoactivity effect. Non interactions are observed to C (FIG. 23E). Bandgap measured to Z and T is as follows: 3.1±0.3 and 3.3±0.4 (Ev) respectively, thus, it is possible to Z and T passing from a valence band to a conductivity band.

From the above-mentioned results, a best combination way of the nanoparticles was performed, and UV-VIS spectrum was evaluated to different combinations since a change to the peak position, curve form and general absorbance, reveals if such change is positive or negative. Initial combinations were as follows: T, T−Z, T−CO, T−A, T−C, Z, Z−T, Z−CO; Z−A and Z−C.

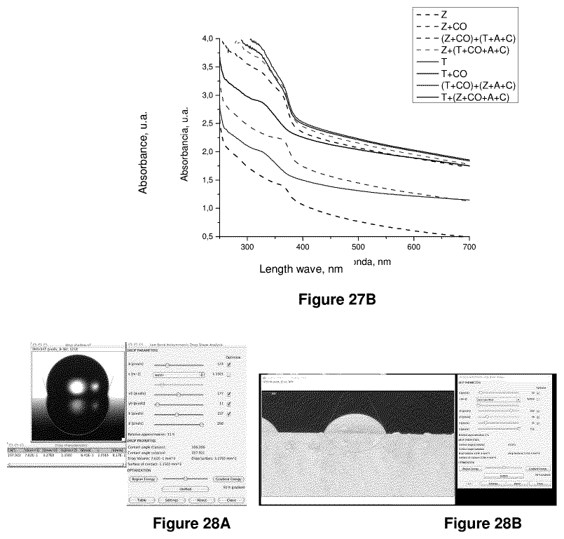

FIG. 27A shows that when mixture starts with T a greater intensity is observed, being the most intensive signals to T+Z and T+CO. T+Z shows a combination of peaks, a loose of a Z signal and a T signal slightly displaced. T+CO shows an increase of absorbance to the whole spectrum, a displacement of T signal and an increase of the greater absorbance to the visible region, 400-700 nm. While this last is not observed to Z+CO, reflecting a change in the T+CO interaction allowing the capture of energy in the visible range. Thus, combinations starting with T and Z and combinations T+CO and Z+CO were lately evaluated, such as, (T−CO)−(Z−A−C), (Z−CO)−(T−A−C), T−(CO−Z−A−C), Z−(CO−T−A−C).

From this evaluation and consistently with the previously observed, a greater absorbance in combinations starting with T, being the combination (T+CO)+(Z+A+C) which showed the greatest intensity. Thus, firstly the combination of nanoparticles T and Z with CO, showing the greatest absorbance, were evaluated to the whole spectrum range, 250-300 nm, and a detector of the equipment was saturated, which suggests an activity greater to the one which the detector can determine. Thus, a simultaneous T+CO addition is made and then Z+A+C is added, which previously was simultaneously made. This order of combination was used to obtain a greater photoactivity in all the experiments described in each example provided herewith.

To evaluate the manufacture an adjusted mixture (20% present additive) was used according to what is mentioned before and a surfactant (Tween80®) and co-surfactant (oleic acid) were added to obtain a stable and fluent dispersion. A mechanical paddle agitator was used to mix at 2000 rpm. Parameters evaluated are as follows: pH, surfactant/co-surfactant charge, height of the phase separation. Table 28 shows a data summary and analyzed parameters.

TABLE 28

| Parameter to | Interactions | | | | | | |
|---|---|---|---|---|---|---|---|
| be evaluated | 1 | 2 | 3 | 4 | 5 | 6 | 7 |
| Solid load, % | 10 | 7.5 | 15.25 | 15.15 | 15.25 | 15.25 | 15.25 |
| Water mass, g | 225 | 185 | 225 | 225 | 225 | 225 | 1000 |
| Agitation | 1 | 1 | 1 | 3 | 3 | 3 | 5 |
| cycles | | | | | | | |
| Break time | Not | Not | Not | Not | 5 | 5 | 5 |
| between | defined | defined | defined | defined | | | |
| cycles, min | | | | | | | |
| Oleic Acid, % | 0.1 | 0.1 | Without | 0.1 | 0.1 | 0.1 | 0.1 |
| | | | Oleic Acid | | | | |
| Tween 80 ®, % | 0.1 | 0.1 | 0.1 | 0.1 | 0.1 | 0.1 | 0.1 |
| Ethanol, ml | 0 | 0 | 0 | 5 | 0 | 0 | 0 |
| pH | Nd | nd | Nd | Nd | nd | Nd | 8.22 |
| Type of | Schott | Schott | Schott | Schott | Schott | Schott | Schott |
| container | 500 ml | 500 ml | 500 ml | 500 ml | 500 ml | 500 ml | 1 L and |
| | | | | | | | 500 ml |
| Separation | 20 | 24 | 17 | 10 | 7 | − | 20 |
| Height, mm | | | | | | | |

| Parameter to | Interactions | | | | | | |
|---|---|---|---|---|---|---|---|
| be evaluated | 8 | 9 | 10 | 11 | 12 | 13 | 14 |
| Solid load, % | Derived | Derived | 20 | 15.25 | 15.25 | 15.25 | 15.25 |
| | from | from | | | | | |
| | sample 6 | sample 6 | | | | | |
| Water mass, g | Derived | Derived | 200 | 200 | 200 | 200 | 200 |
| | from | from | | | | | |
| | sample 4 | sample 6 | | | | | |
| Agitation | 5 + 3 | 5 + 5 | 5 | 5 | 5 | 5 | 5 |
| cycles | | | | | | | |
| Break time | 5 | 5 | 5 | 5 | 5 | 5 | 5 |
| between | | | | | | | |
| cycles, min | | | | | | | |
| Oleic Acid, % | 0.125 | 0.125 | 0.1 | 0.1 | 0.125 | 0.1 | 0.125 |
| Tween | 0.125 | 0.125 | 0.1 | 0.1 | 0.125 | 0.1 | 0.125 |
| 80 ®, % | | | | | | | |
| Ethanol, ml | 0 | 0 | 0 | 0 | 0 | 0 | 0 |
| pH | Lately | 8.22 | Not | 9 | 9 | 9 | 9 |
| | adjusted | | adjusted | | | | |
| | to 9 | | | | | | |
| Type of | 500 ml | 1 L | Schott | Schott | Schott | Schott | Schott |
| container | | | 500 ml | 500 ml | 500 ml | 500 ml | 500 ml |
| Separation | 0 | 20 | 0 | 20 | 20 | 20 | 0 |
| Height, mm | | | | | | | |

Surfactante (S) and co-surfactant (CS) addition (0.125%) was optimal and can be initially mixed with water at 2000 rpm for 10 min or up to achieve a homogeneous solution. Such homogeneous solution is added to T and CO and submitted to agitation (2000 rpm) without a rest up to agglomerates are visibly broken and a light gray fluent past is obtained. Z-A-C is simultaneously added to such past under agitation and after confirmed the absence of agglomerates, agitation is kept for 10 min to then opening a rest of 5 min, which is repeated 3 times. Thus, an additive having a low phase separation and greater stability was obtained. This manufacture procedure can be scaled even up to from 5 to 6 L to the present additive (20%). Stability is preserved for at least 6 months.

### Example 12: Self-Cleaning Test by Measuring Contact Angle

Self-cleaning property of synthetic and water enamel at different nanoparticles concentrations were evaluated. This test was performed according to ISO 27448-1 norm (“Test method for self-cleaning performance of semiconducting photocatalytic materials. Part 1—Measurement of water contact angle”). Two enamel types were evaluated: 1) Water enamel (Tricolor®—professional line—having antibacterial protection) at different nanoparticles concentrations. 2) Synthetic enamel (Tricolor®—professional line—free of stain adherence) at different nanoparticles concentrations.

90 g enamel (synthetic and water) and 3 g nanoparticle according to the matrix of Table 29:

TABLE 29

| Sample | Nanoparticle Name | Amount, g |
|---|---|---|
| 1 | T | 2.10 |
| | CO | 0.90 |
| 2 | T | 1.30 |
| | CO | 0.60 |
| | Z | 1.10 |
| 3 | T | 1.11 |
| | CO | 0.47 |
| | Z | 0.95 |
| | A | 0.47 |
| 4 | T | 1.05 |
| | CO | 0.45 |
| | Z | 0.90 |
| | A | 0.45 |
| | C | 0.15 |

0.5 g of the final mixture (enamel+nanoparticles) are applied on a ceramic surface. Surface of sample is coated with an oleic acid film and then a modification of contact angle value is made using an UV length wave light with regulated power to a water drop which is dropping on the surface of each sample. Self-cleaning action is developed by measuring the contact angle of pure oleic acid (t=0) and the variation of such angle due to an eventual degradation under UV irradiation of the deposited acid, which can be caused only if the supporting material has photocatalytic properties. Measurements are concluded when the measuring value is identical to the obtained samples before the oleic acid contamination if a contact angle value variation is observed. A photocatalytic material can be denominated self-cleaner when experimentally a variation in the contact angle value (initial vs final, after 76 hours tested) is confirmed and caused by the oleic acid degradation located at the surface. To compare, a measurement is repeated on a sample similarly coated with oleic acid but maintained under darkness for a 76-hours. Thus, it can be unequivocally stated that any modification in the contact angle value is exclusively due to the photodegradation of the contaminant molecule by UV radiation and the photocatalytic efficacy of the material submitted to test but not to natural oleic acid degradation which are not related to photocatalysis.

Sample is enamel coated ceramic by a side. Firstly, a ceramic, paint or varnish sample is manufactured to generate a homogeneous film wherein the coating mass is measured prior to carry out an assay. Also, an oleic acid solution is prepared in n-hexane (0.5%V in a 250 ml volumetric flask and added 1.25 mL oleic acid and screeded with n-hexane). Samples are submitted to UV radiation for 16 hours to degrade any organic compound can alter the system as prepared and be able to observe the water drop form in the surface after irradiated. By photographs the changes from the irradiation admission until sterilization are recorded. Samples are submerged in a solution for 5 min and then dried at 70ºC for 15 min, and the initial contact angle is measured at room temperature. After, water drops are added on the prepared surface, and by means photographs forms on the surface are recorded. Contact angle was evaluated using software ImageJ. See FIG. 28. Later samples were uninterruptedly irradiated for 2, 4, 6, 24 and 48 hours. Then, repeating and observing changes in form and contact angle for 72 hours of irradiation. When surface is similar to the one of oleic acid the assay is ended.

FIGS. 28A and 28B show imagens taken from the mentioned software to different steps, preparation and iteration.

Table 30 show the results of contact angle measurements to a ceramic free of oleic acid treatment (AO), t=0 (with AO treatment but free of UV radiation A), 48 hours UV exposure and 72 hours UV exposure. 5 measurements per ceramic per time were taken, and average and STD were calculated.

TABLE 30
Contact angle results

| | | Without | | | |
|---|---|---|---|---|---|
| Enamel | Nanoparticles | AO | T = 0 h | T = 48 h | T = 72 h |
| EA | T | 57.7 | 65.3 | 60.8 | 52.1 |
| ES | T | 66.6 | 62.2 | 50.1 | 44.1 |
| EA | T + CO | 57.1 | 35.2 | 34.6 | 41.8 |
| ES | T + CO | 76.2 | 62.4 | 64.2 | 62.5 |
| EA | T + CO + Z | 60.5 | 62.8 | 55.8 | 51.4 |
| ES | T + CO + Z | 80.3 | 73.2 | 64.2 | 63 |
| EA | T + CO + Z + A | 62 | 56.7 | 63.6 | 55.1 |
| ES | T + CO + Z + A | 69.9 | 84.1 | 70.1 | 59.4 |

EA = water enamel.
ES = synthetic enamel

TABLE 31
Contact angle measurements, synthetic
enamel (ES) and water enamel (EA) + T

| N° contact angle measurement | | | | | | |
|---|---|---|---|---|---|---|
| 1 | 2 | 3 | 4 | 5 | average | STD |

EA + T

| | | | | | | | |
|---|---|---|---|---|---|---|---|
| free | 56.7 | 54.5 | 59.3 | 60.2 | 57.7 | 57.7 | 2.0 |
| AO | | | | | | | |
| 0 | 58.034 | 64.6 | 74.1 | 69.05 | 60.9 | 65.3 | 5.7 |
| 2 | 58.15 | 57.18 | 56.19 | 63.3 | 67.19 | 60.4 | 4.2 |
| 4 | 56.8 | 61.1 | 63.7 | 61.08 | 58.4 | 60.2 | 2.4 |
| 6 | 55.14 | 61.161 | 65.6 | 66.03 | 62 | 62.0 | 3.9 |
| 24 | 65.09 | 67.07 | 61..3 | 64.2 | 65.8 | 64.7 | 1.9 |
| 48 | 57.5 | 66.9 | 64.4 | 55.2 | 60.5 | 60.8 | 4.4 |
| 72 | 49.5 | 54.9 | 53.13 | 51.05 | 52.1 | 52.1 | 1.8 |

ES + T

| | | | | | | | |
|---|---|---|---|---|---|---|---|
| Sin | 66.75 | 64.15 | 69.33 | 67.38 | 65.3 | 66.6 | 1.8 |
| AO | | | | | | | |
| 0 | 62.12 | 66.34 | 60.21 | 61.35 | 61.2 | 62.2 | 2.1 |
| 2 | 67.2 | 69.79 | 68.29 | 70.1 | 68.2 | 68.7 | 1.1 |
| 4 | 61.13 | 59.41 | 61.78 | 57.05 | 58.03 | 59.5 | 1.8 |
| 6 | 62.6 | 61.9 | 60.2 | 60.56 | 60.4 | 61.1 | 0.9 |
| 24 | 58.3 | 59.1 | 57.23 | 58.3 | 59.2 | 58.4 | 0.7 |
| 48 | 45.6 | 49.6 | 49.56 | 52.2 | 53.5 | 50.1 | 2.7 |
| 72 | 42.3 | 42.33 | 42.45 | 52.1 | 41.3 | 44.1 | 4.0 |

TABLE 32
Contact angle measurements, synthetic enamel (ES)
and water enamel (EA) + T + CO

| EA + | N° contact angle measurement | | | | | | |
|---|---|---|---|---|---|---|---|
| T + CO | 1 | 2 | 3 | 4 | 5 | average | Std |
| free AO | 55.6 | 54.5 | 59.3 | 54.7 | 61.5 | 57.1 | 2.8 |
| 0 | 33.2 | 34.4 | 36.8 | 36.5 | 35.2 | 35.2 | 1.3 |
| 2 | 30 | 31.4 | 24.7 | 24.71 | 28.61 | 27.9 | 2.7 |
| 4 | 21.6 | 12.86 | 13.6 | 0 | 0 | 9.6 | 8.4 |
| 6 | 6.001 | 9.2 | 7.6 | 7.6 | 7.6 | 7.6 | 1.0 |
| 24 | 9.2 | 21.7 | 22.015 | 17.6 | 17.6 | 17.6 | 4.6 |
| 48 | 26.1 | 26.109 | 43.1 | 43.11 | 34.6 | 34.6 | 7.6 |
| 72 | 28.9 | 42.1 | 35.86 | 52.14 | 50.13 | 41.8 | 8.7 |
| ES + | N° contact angle measurement | | | | | | |
| T + CO | 1 | 2 | 3 | 4 | 5 | average | STD |
| free AO | 81 | 80.3 | 76.95 | 72.6 | 70.3 | 76.2 | 4.2 |
| 0 | 56.51 | 57.7 | 56.5 | 72.28 | 69.07 | 62.4 | 6.8 |
| 2 | 58.35 | 56.77 | 71.38 | 53.5 | 49.5 | 57.9 | 7.4 |
| 4 | 42.5 | 43.1 | 53.1 | 49.7 | 47.1 | 47.1 | 4.0 |
| 6 | 55.8 | 55.39 | 71.2 | 72.8 | 68.49 | 64.7 | 7.6 |
| 24 | 62.33 | 65.68 | 61.72 | 63.2 | 63.2 | 63.2 | 1.3 |
| 48 | 60 | 63.36 | 64.3 | 65.02 | 68.4 | 64.2 | 2.7 |
| 72 | 61.21 | 63.61 | 61.21 | 62.33 | 63.89 | 62.5 | 1.1 |

TABLE 33
Contact angle measurements, synthetic enamel (ES) and
water enamel (EA) + T + CO + Z

| EA + T + | N° contact angle measurement | | | | | | |
|---|---|---|---|---|---|---|---|
| CO + Z | 1 | 2 | 3 | 4 | 5 | average | Std |
| Free AO | 55.2 | 60.8 | 64.07 | 60.9 | 61.4 | 60.5 | 2.9 |
| 0 | 63.89 | 57.76 | 66.42 | 65.96 | 60 | 62.8 | 3.4 |
| 2 | 53.89 | 54.76 | 60.7 | 63.41 | 62.96 | 59.1 | 4.0 |
| 4 | 48.5 | 57.5 | 60.5 | 55.5 | 55.5 | 55.5 | 3.9 |
| 6 | 48.5 | 57.5 | 60.5 | 55.5 | 55.5 | 55.5 | 3.9 |
| 24 | 54.17 | 65.5 | 67.1 | 65.09 | 63 | 63.0 | 4.6 |
| 48 | 53.1 | 60.45 | 56.2 | 53.77 | 55.67 | 55.8 | 2.6 |
| 72 | 47.59 | 47.59 | 52.7 | 52.7 | 56.45 | 51.4 | 3.4 |
| ES + T + | N° contact angle measurement | | | | | | |
| CO + Z | 1 | 2 | 3 | 4 | 5 | average | STD |
| Free AO | 91.97 | 89.377 | 77.16 | 71.68 | 71.3 | 80.3 | 8.8 |
| 0 | 74.17 | 74.17 | 71.59 | 69.64 | 76.2 | 73.2 | 2.3 |
| 2 | 60 | 53.81 | 69.172 | 41.41 | 36.68 | 52.2 | 11.9 |
| 4 | 46.37 | 49.29 | 49.73 | 48.19 | 45.75 | 47.9 | 1.6 |
| 6 | 33.86 | 42.16 | 42.16 | 47.78 | 51.021 | 43.4 | 5.9 |
| 24 | 64.15 | 47.7 | 46.29 | 48.7 | 56.94 | 52.8 | 6.8 |
| 48 | 64.37 | 61.72 | 73.66 | 57.2 | 64.2 | 64.2 | 5.4 |
| 72 | 61.13 | 67.71 | 66.42 | 68.9 | 50.64 | 63.0 | 6.7 |

TABLE 32
Contact angle measurements, synthetic enamel (ES) and water
enamel (EA) + T + CO + Z + A

| N° Contact angle measurement | | | | | | |
|---|---|---|---|---|---|---|
| 1 | 2 | 3 | 4 | 5 | average | STD |

EA + T + CO + Z + A

| | | | | | | | |
|---|---|---|---|---|---|---|---|
| Free AO | 63.2 | 61.08 | 63.02 | 61.2 | 61.4 | 62.0 | 0.9 |
| 0 | 60 | 60 | 53.65 | 55.5 | 54.3 | 56.7 | 2.8 |
| 2 | 42.8 | 46.5 | 49.07 | 54.3 | 56.9 | 49.9 | 5.1 |
| 4 | 52..9 | 42.4 | 46.1 | 45.07 | 58.5 | 49.0 | 5.9 |
| 6 | 56.7 | 57.4 | 59.19 | 54.9 | 56.9 | 57.0 | 1.4 |
| 24 | 48.1 | 53.1 | 50.7 | 59.2 | 56.07 | 53.4 | 3.9 |
| 48 | 55.37 | 67.9 | 60.9 | 64.4 | 69.2 | 63.6 | 5.0 |
| 72 | 56.25 | 58.03 | 51.31 | 56.25 | 53.86 | 55.1 | 2.3 |

ES + T + CO + Z + A

| | | | | | | | |
|---|---|---|---|---|---|---|---|
| Free AO | 75.2 | 63.2 | 69.15 | 72.5 | 69.35 | 69.9 | 4.0 |
| 0 | 88.2 | 93.95 | 82.07 | 79.5 | 76.99 | 84.1 | 6.2 |
| 2 | 74.4 | 68.67 | 75.99 | 73.39 | 63.25 | 71.1 | 4.6 |
| 4 | 63.42 | 60 | 72.2 | 70 | 71.54 | 67.4 | 4.8 |
| 6 | 70.1 | 57.12 | 45.96 | 49.37 | 50.24 | 54.6 | 8.6 |
| 24 | 66.8 | 68.38 | 63.25 | 72.89 | 70.52 | 68.4 | 3.3 |
| 48 | 70.1 | 68.44 | 67.38 | 73.2 | 71.3 | 70.1 | 2.1 |
| 72 | 57.12 | 62.18 | 57.12 | 57.12 | 63.6 | 59.4 | 2.9 |

Sample water enamel+T shows a contact angle progressively increased after irradiated from t=0 up to t=72 hours, turning to almost an original value which is measured before applying oleic acid in surface, which is caused by the photocatalytic efficiency of material, which can degrade oleic acid under UV irradiation. After 72 hours, oleic acid has been almost totally degraded and contact angle becomes near to the original value showed by the ceramic. As opposed, synthetic enamel+T shows a non-clear behavior because of contact angle at 72 hours is 20° lower to the original angle.

After added T+CO to water enamel the contact angle is kept in relation to the same analysis to EA+T (both, 57°). But after AO treatment the surface is turned much hydrophilic, achieving 35° at t=0 and even 6° at t=6. Finally, at 72 hours the value is slowly near to original value (42° vs 57°). To synthetic enamel+T+CO, a angle 76° can be observed, which is 10° greater to synthetic enamel+T (66°). Thus, after added CO the surface is more hydrophobic. Otherwise, after the first 4 hours of radiation contact angle decreases up to 47°, and then, the same increases up to app. 64°, showing little variations ±1° between 48 and 72 hours. The behavior of synthetic enamel+T+CO+Z, is similar to ES+T+CO.

Samples EA+T+CO+Z show an initial contact angle 3° greater compared to EA+T and EA+T+CO. Further, a variation of angles vs time is observed but the same is lower notorious to the above mentioned cases. The similar occurs to EA+T+CO+Z+A and ES+T+CO+Z+A.

Thus, EA+T, EA+T+CO, are self-cleaning products since the same show a variation in the contact angle at the beginning and at the end of the tests (72 hours) caused by the oleic acid degradation after located at the surface of the particle.

1. A high-efficient and broad-spectrum decontaminant and disinfectant additive comprising metal oxide nanoparticles in a metallic or semi-metallic nanoparticle matrix or a graphene or graphene-derived matrix, wherein such metal oxide nanoparticles are TiO₂, ZnO, Al₂O₃, and CuO.

2. The decontaminant and disinfectant additive of claim 1 wherein such metallic or semi-metallic nanoparticle matrix are selected from metallic or semi-metallic nanocatalyst matrix.

3. The decontaminant and disinfectant additive of claim 2 wherein such metallic or semi-metallic nanocatalyst matrix is selected from a nanocopper matrix, nanogold matrix or a nanosilver matrix.

4. The decontaminant and disinfectant additive of claim 3 wherein such nanometal matrix is a nanocopper matrix.

5. The decontaminant and disinfectant additive of claim 2 wherein the ratio TiO₂:ZnO:Al₂O₃:CuO is 35:30:15:15-3.

6. The decontaminant and disinfectant additive of claim 1 wherein TiO₂:ZnO:Al₂O₃:CuO:Cu is 0−<50:0−<50:0−<50:0−<20:0−<20.

7. The decontaminant and disinfectant additive of claim 1 wherein TiO₂:ZnO:Al₂O₃:CuO:Cu is 35:30:15:15-3:5.

8. The decontaminant and disinfectant additive of claim 1 wherein such metal oxide nanoparticles having a range of nanoparticle size from 10 nm to 150 nm.

9. The decontaminant and disinfectant additive of claim 8 wherein the range of nanoparticle size of ZnO is from 10 nm to 100 nm.

10. The decontaminant and disinfectant additive of claim 8 wherein the range of nanoparticle size of Al₂O₃ is from 10 nm to 100 nm.

11. The decontaminant and disinfectant additive of claim 8 wherein the range of nanoparticle size of TiO₂ is from 10 nm to 30 nm.

12. The decontaminant and disinfectant additive of claim 8 wherein the range of nanoparticle size of CuO is from 40 nm to 60 nm.

13. The decontaminant and disinfectant additive of claim 4 wherein such nanocopper matrix having a nanoparticle size <100 nm.

14. The decontaminant and disinfectant additive of claim 1 wherein such Al₂O₃ nanoparticles are γAl₂O₃ nanoparticles.

15. The decontaminant and disinfectant additive of claim 1 wherein such TiO₂ nanoparticles are TiO₂ anastase phase nanoparticles.

16. The decontaminant and disinfectant additive of claim 1 wherein further comprises superplasticizer.

17. The decontaminant and disinfectant additive of claim 16 wherein such superplasticizer is selected from an anionic surfactant having functional groups selected from hydroxyl, sulphonate or carboxyl; plastificizers/water reducers having a reducing power within a percent range of 5-12%, which can be selected from modified lignosulphonates or hydroxycarboxylic acids; superplastificizers/water reducers having a high reducing activity within a percent value >12%), which can be selected from condensed salts of sulphonated naphthalene and formaldehyde (SNF); condensed salts of sulphonated melamine and formaldehyde (SMF); Polymers of vinylic synthesis and/or polycarboxylate polyeters (PCE).

18. The decontaminant and disinfectant additive of claim 17 wherein such superplasticizer is a polycaboxylate-based superplasticizer.

19-25. (canceled)

26. The decontaminant and disinfectant additive of claim 1 wherein such additive is a powder “ready-to-use”, a solution to be sprayed as a liquid or a formulation to be spread on a soft or hard surface.

27-28. (canceled)

29. A method for decontaminant and disinfectant soft or hard surfaces comprising adding a decontaminant and disinfectant additive as claimed in claim 1 into a product for protecting, coating or decorating soft or hard surfaces and applying such product on a soft or hard surface.

30. Method for removing/eliminating organic contaminants from a liquid mass in contact with hard or soft surfaces comprising adding a decontaminant and disinfectant additive as claimed in claim 1 into a product for protecting, coating or decorating soft or hard surfaces and applying such product on a soft or hard surface in contact with a liquid mass.

31. Method for preparing a decontaminant and disinfectant asphaltic mixture, concrete sealing, polymer masterbatch, among others, comprising adding a decontaminant and disinfectant additive as claimed in claim 1 into an asphaltic mixture, a concrete sealing, a polymer masterbatch, among others.

32. Method for decontaminant soft or hard surfaces comprising adding a decontaminant and disinfectant additive as claimed in claim 1 into a product for protecting, coating or decorating soft or hard surfaces and applying such product on a soft or hard surface.

33. The method of claim 32, wherein the decontaminant hard surface is selected from indoor or outdoor hard surfaces.

34. The method of claim 33 wherein decontaminant indoor or outdoor hard surface is selected from building walls, building coatings, furniture surface, stair railway surface or indoor or outdoor surface of houses, schools, hospitals or buildings, industrial surfaces including settling pools, inner or outer walls of industrial reactors, polymer pieces.

35. The method of claim 32 wherein the decontaminant soft surfaces is selected from fabrics, plastic films or filter membranes.

36. The method of claim 29 wherein such additive is a powder “ready-to-use” additive.

37. The method of claim 30 wherein such contaminants are selected from CO, CO₂, NO, NO₂, SO₂, H₂S, COVs, methane, ammonia, formaldehyde, particulate material, lead, polycyclic aromatic compounds such as benzopyrene, benzene, xylene, trimethylbenzene and aliphatic hydrocarbons, hydrogen fluoride or hydrated hydrogen fluoride/hydrofluoric acid, methylene chloride and chlorofluorocarbons (CFCs), virus, bacteria and molds.
